(19) United States
(12) Patent Application Publication
(10) Pub. No.: US 2023/0311094 A1
(43) Pub. Date: Oct. 5, 2023

(54) METHOD FOR PREPARING ACTIVATED CARBON

(71) Applicant: The Regents of the University of California, Oakland, CA (US)

(72) Inventors: Kandis Leslie Abdul-Aziz, Riverside, CA (US); Mark Gale, Riverside, CA (US); Marissa Moreno, Riverside, CA (US)

(21) Appl. No.: 18/110,292

(22) Filed: Feb. 15, 2023

Related U.S. Application Data
(60) Provisional application No. 63/323,292, filed on Mar. 24, 2022.

(51) Int. Cl. B01J 20/20; C01B 32/324; C01B 32/348; B01J 20/30; B01J 20/28; C02F 1/28; C10B 53/02; C10B 53/07

(52) U.S. Cl. CPC B01J 20/20; C01B 32/324; C01B 32/348; B01J 20/3078; B01J 20/3085; B01J 20/28064; C02F 1/283; C10B 53/02; C10B 53/07; C01P 2006/12; C01P 2002/72; C01P 2004/03; C01P 2002/82; C01P 2004/02; C02F 2101/34

(57) ABSTRACT

The invention provides methods for preparing activated carbon and biochar from a composition that comprises agricultural waste and that optionally comprises plastic. The invention also provides activated carbon and biochar having unique properties.

### CROSS-REFERENCE TO RELATED APPLICATION

This application claims priority to U.S. Provisional Application No. 63/323,292 that was filed on Mar. 24, 2022. The entire content of the application referenced above is hereby incorporated by reference herein.

### BACKGROUND

In a circular bioeconomy, maximizing the use of lignocellulosic biomass waste is paramount for the full utilization of energy, products, and chemical commodities with minimal environmental harm. For example, corn stover is one of the most produced agricultural residues in the United States and is one of the primary feedstocks for cellulosic ethanol. Corn stover, consisting of stalks, leaves, and cobs, was removed from approximately 6.3% of corn operations in the United States, suggesting an ample supply with a minimal demand. In addition to bioethanol, corn stover can be used for other purposes, including fibers, hydrocarbons, and animal feed. The full utilization of lignocellulosic biomass by turning corn stover into value-added products will help progress the circular bioeconomy, increase the agricultural sector's profitability, and decrease the dependence on non-renewable resources.

One beneficial and low-cost value-added product that can be produced from corn stover is activated carbon (AC). AC is a high surface area, porous structure made from various carbon sources using either a direct one-step or a two-step process requiring an initial carbon precursor before activation. AC has several uses, especially as an adsorbent for wastewater treatment. Wastewater treatment plants utilize AC to remove pollutants, such as dyes, pharmaceuticals, heavy metals, and organic contaminants. The removal of industrial phenolic waste such as vanillin is especially important because it has adverse environmental effects. The adsorbent capacity is often one of the key metrics used to evaluate the effectiveness of ACs. Converting agricultural residues into AC for wastewater treatment can lower the costs and create a more sustainable pathway to clean drinking water.

AC properties, such as surface functional groups, pore size, and surface area, can be modified to fit the desired criterion or application. The AC properties can often be tailored by changing the reaction parameters for the preparation of biochar precursors and activation methods. One way to form biochar precursors is the use of hydrothermal carbonization (HTC). HTC is a green process that uses mild temperatures, water as a solvent, and an inert environment. HTC can produce three fractions: solid (char), liquid (bio-oil), and gas. This process is performed at a point where water is subcritical, which is useful in breaking down the polymeric backbone of the biomass. HTC uses temperatures between 180 and 250° C. and has several advantages compared to pyrolysis, including lower energy inputs, no need of drying the feedstock, reduced ash content, and higher solid yields. Pyrolysis, an alternative to HTC, is a standard thermal method to convert biomass into biochar. It can use low or high temperatures with little to no oxygen. There are three major categories of pyrolysis based on the duration and associated temperature ramp: flash, slow, and fast pyrolysis. For slow pyrolysis (SP), the ramp rate is on the order of minutes or hours, ranging between 10° C./min and 10° C./h. The temperature range is lower than that of the flash pyrolysis, between 300 to 700° C. To optimize biochar production, one should focus on utilizing low temperatures and moderate ramp rates like that of SP.

AC can be made from biochar precursors using either physical or chemical activation. Physical activation requires two separate steps: first with pyrolysis or thermal treatment and then exposure to an oxidizing gas such as steam or CO₂. Chemical activation can be done either by a direct one-step process or a two-step process. The direct one-step process involves impregnating or mixing biomass with a chemical activating agent under thermal treatment. In the one-step method, the carbonization and activation step are performed simultaneously. The two-step process is done by an initial carbonization step to form biochar, followed by thermal activation. Several types of chemicals can be used as activating agents, including K₂CO₃, NaOH, ZnCl₂, and KOH. In all cases, the activating agent is used with an ideal ratio to biomass to ensure complete activation and formation of pores and improved surface area. Several groups have studied the activation mechanism using KOH. Huang et al. found that KOH reacts with carbon around 530° C. to produce K₂O and K₂CO₃, which react to create metallic K and a graphite-like microcrystalline structure. Otowa et al. also found the formation of K₂O by dehydration and K₂CO₃ by a carbonate reaction. Metallic K is formed and intercalated in the carbon matrix at high temperatures, resulting in atomic layers of carbon being widened and forming pores.

Currently there is a need for improved methods for preparing activated carbon. In particular, there is a need for methods that are less expensive (e.g., use less activating reagent or produce less waste) and/or that provide better control of the properties of the carbon product.

### SUMMARY

Applicant has identified a process for the thermal conversion of agricultural waste to activated carbon. The conversion process parameters can be varied to modify the properties of the activated carbon for a myriad of applications including pollution abatement of potable water and air purification.

In one aspect the invention provides a method for preparing activated carbon comprising, treating an amount of agricultural waste with less than one weight equivalent of an activating agent to provide the activated carbon.

In another aspect, the invention provides a method for preparing activated carbon comprising:
a) treating agricultural waste with heat to provide a biochar; and
b) treating the biochar with less than one weight equivalent of an activating agent to provide the activated carbon.

In one aspect the invention provides a method comprising: processing agricultural waste to form an activated carbon under conditions using one or more thermal conversion process parameters; and setting the one or more thermal conversion process parameters to form the activated carbon for use in pollution abatement of potable water.

In one aspect the invention provides a method comprising: processing agricultural waste to form an activated carbon by setting one or more thermal conversion process parameters; and setting the one or more thermal conversion process parameters to form the activated carbon for use in air purification.

In one aspect, the invention provides a method for preparing activated carbon comprising: treating a composition that comprises agricultural waste (and optionally plastic) with an activating agent to provide a first reaction mixture; drying the first reaction mixture to provide a dried reaction mixture; heating the dried reaction mixture to a temperature of from about 250° C. to about 350° C. for a period of from about 1 hour to about 3 hours to provide a second reaction mixture; and heating the second reaction mixture to a temperature of from about 700° C. to about 900° C. for a period of from about 2 hour to about 4 hours to provide the activated carbon.

In one aspect, the invention provides a method for preparing activated carbon comprising:
a) treating a composition that comprises agricultural waste (and optionally plastic) with heat to provide a biochar; and
b) treating the biochar with less than one weight equivalent of an activating agent to provide the activated carbon.

In one aspect, the invention provides a method comprising: processing a composition that comprises agricultural waste (and optionally plastic) to form an activated carbon under conditions using one or more thermal conversion process parameters; and setting the one or more thermal conversion process parameters to form the activated carbon for use in pollution abatement of potable water.

In one aspect, the invention provides a method comprising: processing a composition that comprises agricultural waste (and optionally plastic) to form an activated carbon by setting one or more thermal conversion process parameters; and setting the one or more thermal conversion process parameters to form the activated carbon for use in air purification.

In one aspect, the invention provides a method for preparing activated carbon comprising pyrolyzing a composition that comprises agricultural waste and plastic to provide the activated carbon.

In one aspect, the invention provides a method for preparing activated carbon comprising treating biochar with an activating agent to provide a first reaction mixture; drying the first reaction mixture to provide a dried reaction mixture; and heating the dried reaction mixture to a temperature of from about 750° C. to about 850° C. in the presence of a plastic for a period of from about 3 hours to about 5 hours to provide the activated carbon.

In one aspect, the invention provides a method for preparing biochar, comprising treating a composition that comprises agricultural waste and plastic with heat to provide the biochar.

In another aspect the invention provides an activated carbon prepared by a method of the invention.

In another aspect the invention provides a biochar prepared by a method of the invention.

In another aspect the invention provides an activated carbon, or a biochar described herein.

### BRIEF DESCRIPTION OF THE DRAWINGS

FIGS. 1A-1B. (FIG. 1A) XRD spectra of the HTC biochar prepared at different temperatures and a dwell time of 2 hours and (FIG. 1B) Surface areas of the HTC-formed biochar plotted as a function of temperature. FIGS. 2A-2D. SEM images of the HTC biochar at different temperatures and dwell time. (FIG. 2A) Corn stover milled 1 mm (mag: 1.43k×), (FIG. 2B) HTC 220° C. 1 hour (mag: 1.43k×), (FIG. 2C) HTC 220° C. 2 hours (mag: 1.15k×), and (FIG. 2D) HTC 240° C. 4 h (mag: 1.17k×).

FIGS. 3A-3B. (FIG. 3A) XRD spectra for SP of corn stover at different temperatures, (FIG. 3B) Surface area of SP of corn stover for 1 hour over a range of 300-700° C.

FIGS. 4A-4D. SEM images of SP biochar at different temperatures. (FIG. 4A) SP 400° C. 1 hour (mag: 931×), (FIG. 4B) SP 500° C. 1 hour (mag: 1.23k×), (FIG. 4C) SP 600° C. 1 hour (mag: 934k×), and (FIG. 4D) SP 600° C. 1 hour (mag: 1.28k×).

FIG. 5. XRD spectra of AC prepared from corn stover directly and SP and HTC biochars.

FIGS. 6A-6D. SEM images of AC. (FIG. 6A) AC HTC 200° C. 1 hour (mag: 1.14k×), (FIG. 6B) AC HTC 240° C. 2 hour (mag: 1.14k×), (FIG. 6C) AC SP 400° C. 1 hour (mag: 1.0k×), and (FIG. 6D) AC SP 550° C. 1 hour (mag: 1.0k×).

FIGS. 7A-7B. FTIR analysis of the (FIG. 7A) biochar from either the HTC or SP and (FIG. 7B) AC.

FIGS. 8A-8C. Vanillin adsorbate capacity normalized to surface area of the ACs as a function of (FIG. 8A) vanillin concentration, (FIG. 8B) dosage, and (FIG. 8C) time.

FIGS. 9A-9B. Vanillin removal as a percentage of ACs as a function of (FIG. 9A) time and (FIG. B) mass. FIGS. 10A-10B. (FIG. 10A) Average pore size for HTC biochar and (FIG. 10B) Average pore size of SP biochar for various temperatures after 1-hour duration

FIG. 11. Images of hydrothermal carbonization biochar as a function of temperature and duration.

FIGS. 12A-12C. BET Isotherm of (FIG. 12A) AC Direct, (FIG. 12B) AC SP, and (FIG. 12C) AC HTC 240.

FIG. 13. Schematic of pyrolysis reactor used for the experiments in a controlled environment. The reactor contains a tube furnace with a controlled environment of nitrogen. The sample boat is ceramic. A cold trap is adhered to the pyrolysis unit for collection and condensation of pyrolysis oil. The gases are ventilated in a chemical hood.

FIGS. 14A-14C. Live tracking analysis of the mass spectral responses of volatiles produced from (FIG. 14A) corn stover, (FIG. 14B) PET, and (FIG. 14C) PS during a temperature ramp to 500° C.

FIGS. 15A-15F. Thermal degradation studies of the pyrolysis of corn stover and plastics showing the main degradative gaseous products. (FIG. 15A) CS:PET 9:1, (FIG. 15B) CS:PET 4:1, (FIG. 15C) CS:PET 1:1, (FIG. 15D) CS:PS 9:1, (FIG. 15E) CS:PS 4:1, and (FIG. 15F) CS:PS 1:1.

FIGS. 16A-16B. Live tracking analysis of the mass spectral responses of carbon oxides for (FIG. 16A) corn stover and PET, (FIG. 16B) corn stover and polystyrene.

FIGS. 17A-17F. BET isotherm of (FIG. 17A) CS:PS 9:1, (FIG. 17B) CS:PS 4:1, (FIG. 17C) CS:PS 1:1, (FIG. 17D) CS:PET 9:1, (FIG. 17E) CS:PET 4:1, and (FIG. 17F) CS:PET 1:1.

FIGS. 18A-18B. X-ray diffraction spectra of the chars produced from the co-pyrolysis of (FIG. 18A) corn stover and polyethylene terephthalate (CS:PET), (FIG. 18B) corn stover and polystyrene (CS:PS) as a function of the ratio of corn stover to plastics. The spectra are compared to untreated corn stover and char control sample from corn stover (denoted as SP 500° C.).

FIGS. 19A-19B. Fourier-Transform Infrared spectra of (FIG. 19A) corn stover and polyethylene terephthalate (CS:PET), (FIG. 19B) corn stover and polystyrene (CS:PS) as a function of the ratio of corn stover to plastics.

FIGS. 20A-20D. Select images of char formed from the pyrolysis of corn stover and polyethylene terephthalate at 500° C. for 2 hours (FIG. 20A) CS:PET 1:1 l kx, (FIG. 20B) CS:PET 1:1 4.2kx, (FIG. 20C) CS:PET 9:1 lkx, (FIG. 20D) CS:PET 9:1 8kx FIGS. 21A-21C. Select images of char formed from the pyrolysis of corn stover and polystyrene at 500° C. for 2 hours (FIG. 21A) CS:PS 1:1 1.2 kx, (FIG. 21B) CS:PS 4:1 0.95kx. (FIG. 21C) CS:PS 9:1 1.0kx

FIGS. 22A-22B. Image of char derived from the pyrolysis of neat corn stover, (FIG. 22A) char (mag 0.91 kx), (FIG. 22B) activated carbon (mag 1 kx).

FIGS. 23A-23B. XRD spectra of activated carbon samples derived from CS:Plastics char precursors as a function of the mass ratio, (FIG. 23A) ACs from corn stover and polyethylene terephthalate (AC CS:PET), (FIG. 23B) ACs from corn stover and polystyrene (AC CS:PS). The spectra are compared to activated carbon control sample derived from corn stover char (denoted as AC SP 500° C.).

FIGS. 24A-24B. Fourier-Transform Infrared spectra of activated carbon from (FIG. 24A) corn stover and polyethylene terephthalate (AC CS:PET), (FIG. 24B) corn stover and polystyrene (AC CS:PS) as a function of the ratio of corn stover to plastics.

FIGS. 25A-25E. SEM images of select activated carbon samples as a function of the char obtained from the pyrolysis of CS and plastics in various mass ratios, (FIG. 25A) AC from CS:PET 1:1, (FIG. 25B) AC from CS:PET 4:1, (FIG. 25C) AC from CS:PET 9:1, (FIG. 25D) AC from CS:PS 4:1 and (FIG. 25E) AC from CS:PS 9:1.

FIGS. 26A-26B. (FIG. 26A) Vanillin adsorbate capacity normalized to surface area of the ACs as a function of time, (FIG. 26B) Percentage of Vanillin removal as a function of time

FIG. 27. BET isotherm of biochar derived from corn stover only

FIGS. 28A-28F. BET isotherm of (FIG. 28A) AC CS:PS 9:1, (FIG. 28B) AC CS:PS 4:1, (FIG. 28C) AC CS:PS 1:1, (FIG. 28D) AC CS:PET 9:1, (FIG. 28E) AC CS:PET 4:1, and (FIG. 28F) AC CS:PET 1:1.

FIG. 29. BET isotherm of activated carbon from the chemical activation of corn stover biochar

### DETAILED DESCRIPTION

As used herein, the term “agricultural waste” may comprise corn stover, almond husks, citrus peels, rice husks, hemp, nut shells, or one or more vegetables. The term “corn stover” includes stalks, leaves, and cobs of the corn plant.

As used herein, the term “activating agent” includes any agent that is suitable to convert the agricultural waste or the biochar to the activated carbon. In one embodiment the activating agent is K₂CO₃, NaOH, ZnCl₂, NaOH, or KOH. In one embodiment, the activating agent is a strong base, for example, a metal hydroxide base (sodium hydroxide or potassium hydroxide).

In one embodiment, the agricultural waste is treated directly with the activating agent at a temperature of less than about 100° C. In one embodiment, the agricultural waste is treated directly with the activating agent at a temperature of less than about 75° C. In one embodiment, the agricultural waste is treated directly with the activating agent at a temperature of less than about 50° C.

In one embodiment, the weight of the activating agent is less than about 0.75 times the weight of the agricultural waste.

In one embodiment, the weight of the activating agent is less than about 0.6 times the weight of the agricultural waste.

In one embodiment, the weight of the activating agent is less about half the weight of the agricultural waste.

In one embodiment, the weight of the activated carbon is at least 0.1 times the weight of the agricultural waste.

In one embodiment, the weight of the activated carbon is at least 0.15 times the weight of the agricultural waste.

In one embodiment, the agricultural waste is treated with the activating agent to provide a first reaction mixture; the first reaction mixture is dried (for example, at a temperature in the range of about 80° C. to about 120° C. for a period of from about 1 hour to about 5 hours — until dry) to provide a dried reaction mixture; the dried reaction mixture is heated to a temperature of from about 250° C. to about 350° C. for a period of from about 1 hour to about 3 hours to provide a second reaction mixture; and the second reaction mixture is heated to a temperature of from about 700° C. to about 900° C. for a period of from about 2 hour to about 4 hours to provide the activated carbon.

In one embodiment, the agricultural waste is treated with the activating agent to provide a first reaction mixture; the first reaction mixture is dried (for example, at a temperature in the range of about 80° C. to about 120° C. for a period of from about 1 hour to about 5 hours — until dry) to provide a dried reaction mixture; and the dried reaction mixture is heated to a temperature of about 300° C. for a period of about 2 hours to provide a second reaction mixture; and the second reaction mixture is heated to a temperature of about 800° C. for a period of about 4 hours to provide the activated carbon.

In one embodiment, the activated carbon has a surface area of less than about 1200 m²/g. In one embodiment, the activated carbon has a surface area of less than about 1000 m²/g. In one embodiment, the activated carbon has a surface area of less than about 900 m²/g. In one embodiment, the activated carbon has a surface area of less than about 700 m²/g. In one embodiment, the activated carbon has a surface area of about 600 m²/g.

In one embodiment, the invention provides a method for preparing activated carbon comprising:
a) treating agricultural waste with heat to provide a biochar; and
b) treating the biochar with less than one weight equivalent of an activating agent to provide the activated carbon.

In one embodiment, the agricultural waste is treated with heat under hydrothermal carbonization (HTC) conditions at a temperature in the range of about 180° C. to about 240° C. to provide the biochar.

In one embodiment, the agricultural waste is treated with heat under hydrothermal carbonization (HTC) conditions at a temperature of less than about 240° C. to provide the biochar.

In one embodiment, the biochar is treated with the activating agent to provide a first reaction mixture; the first reaction mixture is dried (for example, at a temperature in the range of about 80° C. to about 120° C. for a period of from about 1 hour to about 5 hours — until dry) to provide a dried reaction mixture; and the dried reaction mixture is heated to a temperature of from about 750° C. to about 850° C. for a period of from about 3 hour to about 5 hours to provide the activated carbon.

In one embodiment, the biochar is treated with the activating agent to provide a first reaction mixture; the first reaction mixture is dried (for example, at a temperature in the range of about 80° C. to about 120° C. for a period of from about 1 hour to about 5 hours — until dry) to provide a dried reaction mixture; and the dried reaction mixture is heated to a temperature of about 800° C. for a period of about 4 hours to provide the activated carbon.

In one embodiment, the weight of the activating agent is less than about 0.75 times the weight of the biochar.

In one embodiment, the weight of the activating agent is less than about 0.6 times the weight of the biochar.

In one embodiment, the weight of the activating agent is less about half the weight of the biochar.

In one embodiment, the weight of the activated carbon is at least 0.1 times the weight of the biochar.

In one embodiment, the weight of the activated carbon is at least 0.15 times the weight of the biochar.

In one embodiment, the agricultural waste is provided as a composition that comprises agricultural waste and optionally a plastic, (e.g., polystyrene or polyethylene terephthalate).

In one embodiment, the invention provides a method for preparing biochar, comprising treating a composition that comprises agricultural waste and plastic with heat to provide the biochar. In one embodiment, the biochar has a surface area of at least about 5 m²/g. In one embodiment, the biochar has a surface area of at least about 10 m²/g. In one embodiment, the biochar has a surface area of at least about 25 m²/g. In one embodiment, the biochar has a surface area of at least about 50 m²/g. In one embodiment, the biochar has a surface area of at least about 75 m²/g. In one embodiment, the biochar has a surface area of at least about 90 m²/g. In one embodiment, the biochar has a surface area of at least about 100 m²/g.

In one embodiment, the method of the invention further comprises separating the activated carbon from the activating agent to provide isolated activated carbon. The activated carbon can be separated from the activating agent using any suitable method, for example, by neutralizing the activating agent or by washing with an acid solution to neutralize the.

The activated carbon prepared according to the methods of the invention is useful for removing contaminants (e.g., organic contaminants, such as aromatic organic compounds) from wastewater. In one embodiment, the activated carbon prepared according to the methods of the invention is useful for removing contaminants from wastewater to provide potable water.

The invention will now be illustrated by the following non-limiting Examples.

### EXAMPLES

### Example 1

This study evaluates the influence of hydrothermal carbonization (HTC) or slow pyrolysis (SP) process conditions on the physicochemical properties of precursor biochars and activated carbon (AC). The AC is achieved through a direct or a two-step method with subsequent chemical activation using KOH. A theory is developed on the biochar propensity to be chemically activated based on the lignocellulosic structure composition. X-ray photoelectron spectroscopy elemental analysis shows that the O/C ratio decreases after chemical activation for HTC biochar but remains the same for SP biochar. X-ray powder diffraction indicates that the SP biochar and all ACs have broad amorphous carbon peaks, whereas corn stover and the HTC biochar have distinct cellulosic crystalline peaks. Vanillin adsorbent experiments were performed on various ACs with up to 98% reduction shown. The best adsorbent for vanillin was the AC produced directly from corn stover, followed by AC HTC and then AC SP.

### Results And Discussion

Physiochemical Properties of Biochar. Hydrothermal Carbonization

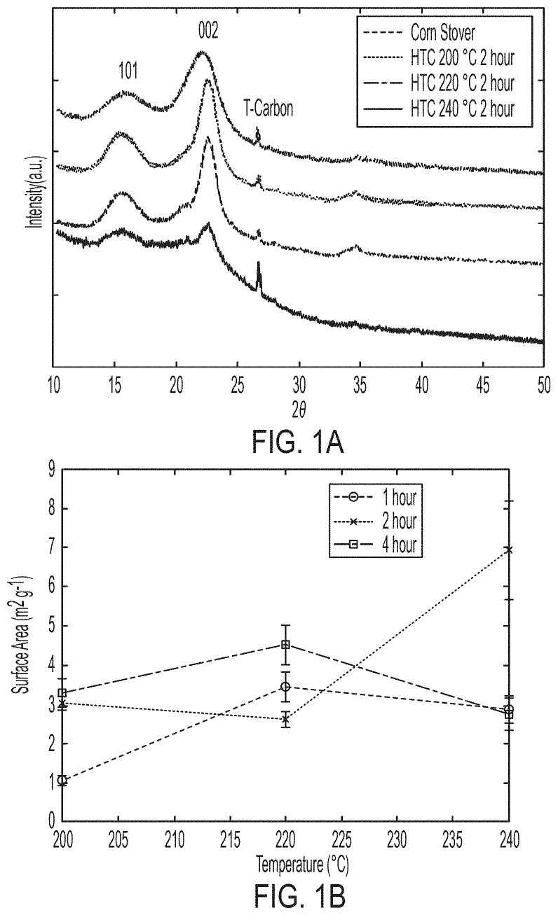

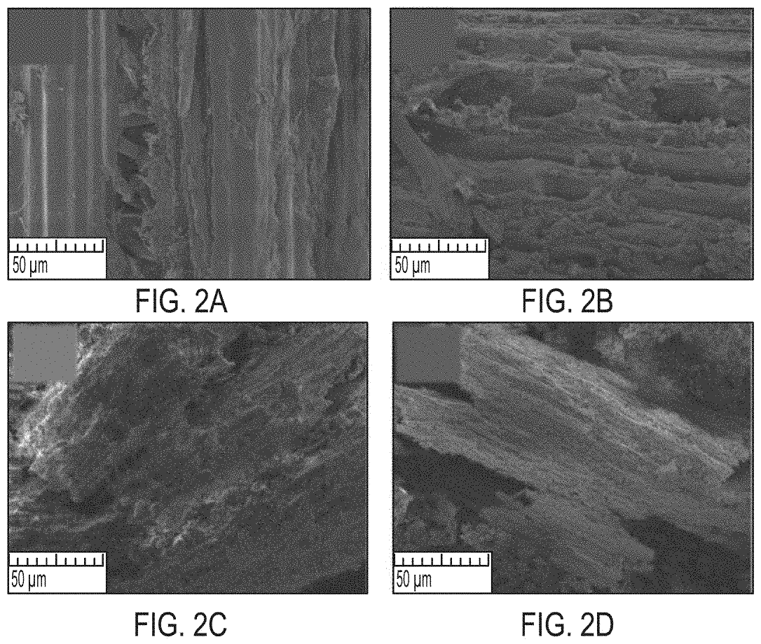

The influence of dwell temperature at 200, 220, and 240° C. on the formed biochar after hydrothermal treatment was studied. FIG 1a shows the X-ray powder diffraction (XRD) pattern of HTC-treated corn stover with a 2-hour dwell time at different temperatures. The patterns are compared with that of untreated corn stover. The XRD pattern of corn stover has prominent cellulosic peaks at ˜16 2θ (101) and ˜22 2θ (220). The cellulosic peaks of the formed biochars decrease in intensity and become broad as the temperature increases. This broadening coincides with the decrease in the crystallite sizes of the cellulose and hemicellulose. It indicates that the HTC process promotes the partial breakdown of the cellulosic and hemicellulosic components of corn stover. Interestingly, the turbostratic carbon (t-carbon) peak at ˜26 2θ increases as the temperature increases, showing the potential growth of graphene layers. T-carbon is a unique class of carbon having structural ordering in between that of amorphous carbon phase and crystalline graphite phase.

FIG. 1b shows the change in the surface area as a function of dwell temperature and time. The biochar formed at 200° C. for 1 hour produced the lowest surface area at 1.0±0.12 m2/g. As the temperature increased to 220° C., the surface area increased to 3.5±0.38 m2/g. This change may coincide with cellulose chains hydrolyzing at temperatures >220° C., as corroborated with our XRD data. At 240° C., the surface area decreased to 2.9±0.34 m2/g. The 20 same trend was observed with the 4 h dwell time at 200, 220, and 240° C. with surface areas of 3.3±0.36, 4.5±0.50, and 2.8±0.41 m2/g, respectively. Based on our XRD and surface area analysis, it is believed that the surface area increases as the biomass constituents are broken down, with the hemicellulose degrading first and the cellulose second. This degradation order would be expected as hemicellulose is much less resistant to hydrolysis than cellulose. Any further thermal degradation of biomass may occur through hydrolysis, isomerization, dehydration, and fragmentation. The surface areas for the 2 hour dwell time at dwell temperatures 200, 220, and 240° C. were 3.0±0.17, 2.6±0.20, and 6.9±1.3 m2/g, respectively. The highest achieved surface area for the HTC experiments was found using a 2 hour dwell time and 240° C. dwell temperature. FIG. 10a shows the average pore size as a function of temperature and dwell time. The average pore size increased when the temperature increased from 200 to 220° C. in all the cases. The increase in the pore size could coincide with the widening of pores caused by cellulose chain hydrolyzing. When the temperature was further increased to 240° C., in the 1 hour run, there was a slight increase in the average pore size, but in the 2 and 4 hour runs, the average pore size decreased.

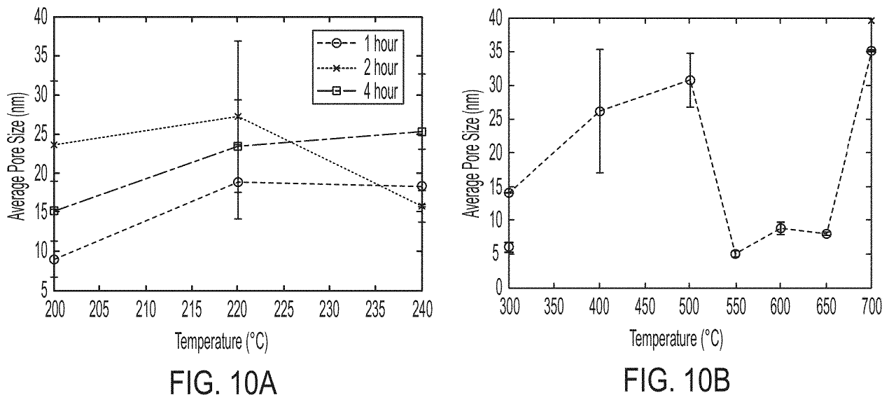

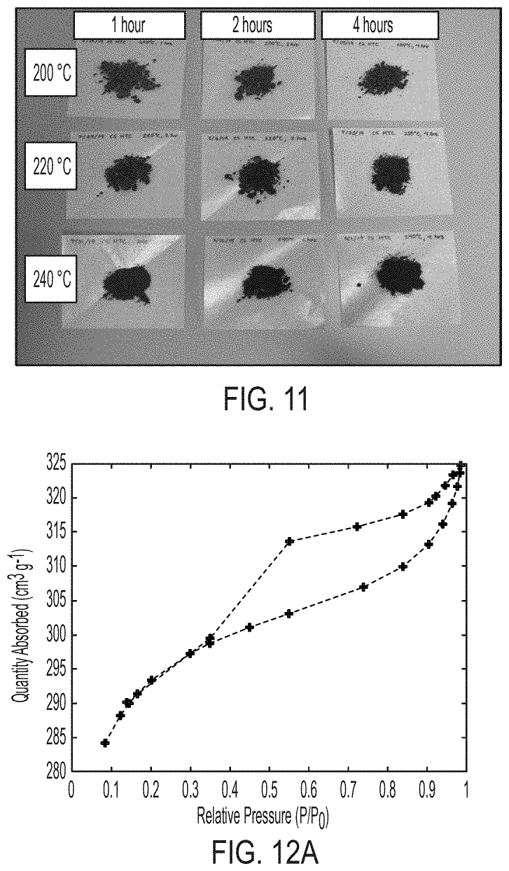

The color of the biochar varied with temperature and dwell time (FIG. 11). The biochar color varied from light brown to a black fine powder consistency. The milled corn stover had the appearance of sawdust prior to the hydrothermal treatment. The color change of the biomass is most likely due to the Maillard reaction and the degradation of the sugars contained in the biomass. The morphological changes of corn stover for select biochar samples were studied using scanning electron microscopy (SEM). FIGS. 2b and 2c show the evolution of corn stover to HTC biochar as a function of temperature and duration. As the temperature and time increase, the surface becomes rougher, indicating structural degradation from the hydrothermal process. FIG. 2a shows the milled corn stover before HTC. The corn stover structure is rigid and fibrous. FIG. 2b shows the biochar formed after the HTC process at 220° C. and 1 hour dwell time. The surface changes are apparent with the formation of pits that are possible starting locations for pore formation. As the temperature and time are increased, as shown in FIGS. 2c and 2d, to 240 ° C. for 4 hour dwell time, the most dramatic changes are observed, with little to no resemblance to the original corn stover. Hydrothermal degradation occurs due to a myriad of simultaneous reactions including hydrolysis, dehydration, and decarboxylation. At higher temperatures, other reaction mechanisms are dominant such as condensation polymerization.

The temperatures of this study are sufficient for the promotion of these simultaneous reactions that become prevalent at 240° C. and promote the degradation of corn stover. The effect of temperature on the properties and morphology of HTC biochar is complex and multifaceted. Despite a greater degree of degradation at higher temperatures, the findings indicate no clear trend in the surface area and pore size.

The ratio of water to biomass was varied from 8:1 to 5:1 or 10:1 at 220° C. to determine if the amount of water influenced the biochar characteristics. Table 2 shows the results for varying the ratio.

TABLE 2
HTC biochar surface area when varying the ratio of
water to biomass and total amount of biomass Slow
pyrolysis biochar surface area with changing duration

| | | Average | |
|---|---|---|---|
| | Surface Area²⁻¹ | Pore Size | |
| Sample | mg | nm | % Recovered |
| HTC 5:1 Ratio^{α} | 2.2 ± 0.24^{ε} | 30 ± 7.6^{ε} | 50.8% |
| HTC 8:1 Ratio^{α} | 2.6 ± 0.41 | 18 ± 4.6 | 46.5% |
| HTC 10:1 Ratio^{α} | 3.6 ± 0.40^{ε} | 35 ± 8.9^{ε} | 49.0% |
| HTC 1 g^{β} | 5.6 ± 0.62^{ε} | 23 ± 5.8^{ε} | 39.3% |
| HTC 5 g^{β} | 2.6 ± 0.41 | 18 ± 4.6 | 46.5% |
| HTC 10 g^{β} | 4.1 ± 0.45^{ε} | 20 ± 5.1^{ε} | 52.7% |
| SP 550° C. 0 hour | 9.9 ± 1.6^{ε} | 33 ± 3.4^{ε} | 29.3% |
| SP 550° C. 1 hour | 111 ± 23 | 5.0 ± 0.51 | 27.8% |
| SP 550° C. 4 hours | 107 ± 18^{ε} | 5.7 ± 0.58^{ε} | 27.0% |
| SP 550° C. 8 hours | 105 ± 17^{ε} | 7.0 ± 0.71^{ε} | 27.4% |

^{α}HTC experiments ran at 220° C. for 2 hours with 5 g of biomass.
^{β}HTC experiments ran at 220° C. for 2 hours with a ratio of 8:1 water to biomass.
^{ε}Approximate error calculated from previous data replicates in similar pretreatment conditions

The 5:1 ratio had the lowest surface area at 2.2±0.24 m2/g, the 8:1 ratio had a higher surface area at 2.6±0.41 m2/g, and the 10:1 ratio had the highest surface area of 3.6±0.40 m2/g. Interestingly, the 8:1 experiment had the lowest solid biochar yield, while the highest biochar yield was achieved from the 5:1 ratio. Considering the solid loss after the experiments, it was surmised that the difference in solid retention is a higher production of liquid and gaseous products for the 8:1 ratio compared to the other ratios. Nevertheless, the higher water-to-biomass ratio improves the surface area and pore structure.

To determine if the reactor's volume influenced the biochar's properties as the amount to charge the reactor the 8:1 ratio for water to biomass was maintained and studied using HTC on 1, 5, and 10 g of biomass. Table 2 shows the comparison of the three different runs as a function of added water volume. The run with 1 g of corn stover achieved the highest surface area at 5.6±0.62 m²/g. However, the biochar yield was very low due to some of the biochar residue adhering to the reactor's walls. The run for the 10 g sample indicated a higher biochar yield but a lower surface area, 4.1±0.45 m2/g. It was surmised that the different mass to reactor volume allowed for different heat transfer rates, which in turn promoted different biochars. Thus, reactor size has significance when optimizing the formation of biochar.

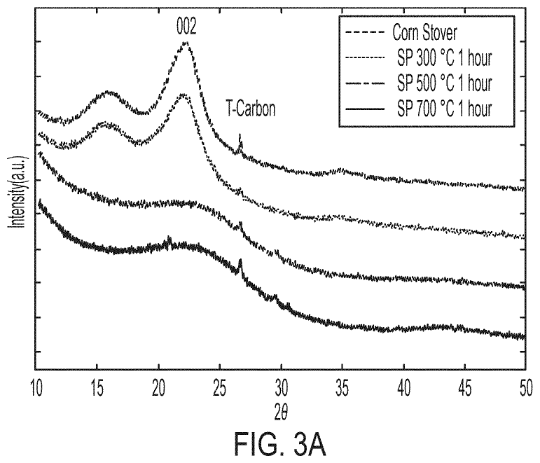

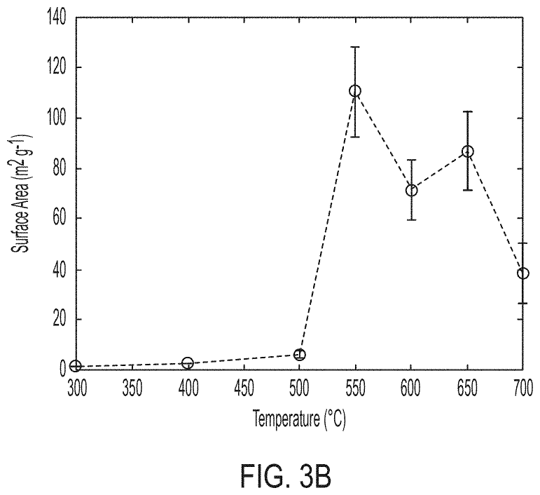

Slow Pyrolysis. FIG. 3a shows the XRD patterns for biochar derived from SP at 300, 500, and 700° C. The XRD spectra for the biochar formed at 300° C. show cellulosic peaks comparable to the peaks for corn stover. This indicates that at 300° C., there was a minimal change in the structural characteristics of the biochar. The biochars formed at 500 and 700° C. are quite different, with the formation of broad peaks between 15 and 30 2θ, resembling amorphous carbon peaks. It was surmised that temperatures above 500° C. were substantial enough to break down the lignocellulosic structure for the complete breakdown of cellulose and hemicellulose. Interestingly, all the HTC biochars have cellulosic peaks, while those of SP biochars at elevated temperatures above 500° C. were apparently amorphous. This is an indication of different reactions occurring in the different carbonization methods. The biochars from SP and HTC are both precursors to AC, and comparing the biochar formed from the two different processes is essential. This breakdown in the structure corresponds to a higher surface area for SP biochar compared to that formed from HTC.

The change of the surface area as a function of the SP temperature is shown in FIG. 3b. The trend shows that as the temperature increases, the solid residue's surface area increases as well. From 300 to 500° C., the surface area went from 1.5±0.03 to 5.0±1.5 m2/g, but once the temperature reaches 550° C., the surface area increases to 111±23 m2/g. An SP 240° C. experiment was conducted to compare with the HTC 240° C. biochar. Compared to HTC, the SP biochar's surface area formed at 240° C. is 1.2±0.2 m2/g versus the HTC biochar's surface area of 6.9±1.3 m2/g. It was surmised that HTC, using subcritical water, may be more effective with breaking the down biomass structure than SP at low temperatures.

The decrease in the pore size and surface area after 550° C. could be due to the limited reactivity of the lignin-rich biochar. The decomposition of hemicellulose and cellulose usually occurs between 200 and 450° C. Particularly, cellulose decomposition reactions dominate between 300 and 450° C. The thermal decomposition of corn stover is limited at low temperatures, and the large concentration of hemicellulose and cellulose limits the surface area and pore morphology. This can be seen when comparing HTC and SP at 240° C., which highlights the impact of subcritical water in breaking down the biomass. Fragmentation becomes a dominating reaction at higher temperatures and is at its maximum around 600° C. The lignin polymeric structure has a higher kinetic threshold for decomposition that dominates at temperatures above 500° C. It is possible that the increase in surface area at 550° C. is primarily due to the decomposition of cellulose and hemicellulose forming high surface area biochar. As the temperature increases, the solid degrades into aromatic species and other hydrocarbons that escape into the gas phase where a portion can be condensed into the oil phase. There is a small spike from 600 to 650° C., which could be due to polymerization and formation of some other products on the solid. Generally, the surface area of the SP carbon samples decreases at higher temperatures, which may be attributed to the formation of large pores.

Initially, the pore size of the samples is mesoporous, then decreases and increases again at elevated temperatures. Table 2 shows the morphological changes of carbon as a function of a change of duration at 550° C. It appears the longer the dwell time, the higher the surface area. However, the increase in the surface area from 1 to 8 hours is less than 5%. The limited change after 1 hour confirms that the reaction reaches steady state in 1 hour. The average pore size is plotted in FIG. 10b as a function of temperature. Interestingly, the average pore size plot is an inverse of the surface area plot between 500 and 700° C., FIG. 10b. As the average pore size decreases, the total surface area increases, which would suggest that there is an increased number of smaller pores that causes the increases in the available surface area. At higher temperatures, a decrease in surface area was observed. The decrease might be attributed to either pore collapse or an increase in the size of the pores, as can be seen for temperatures above 650° C.

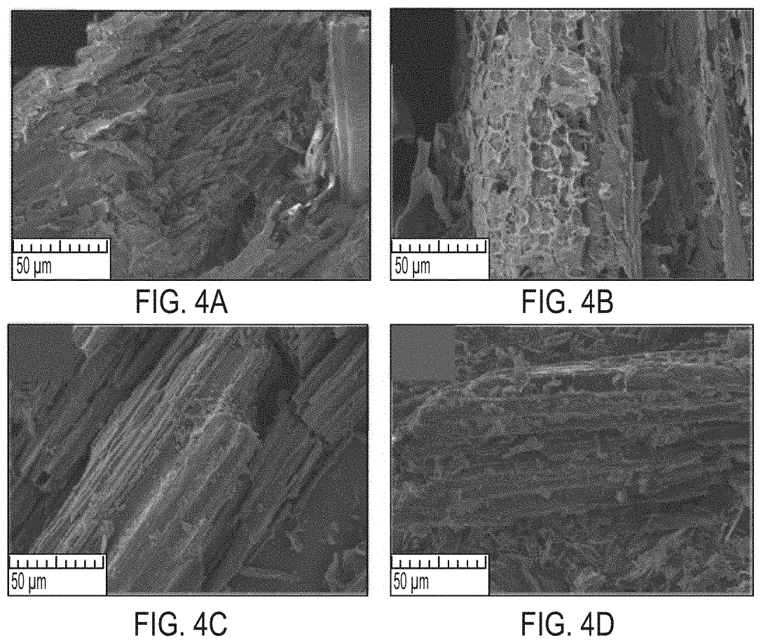

The visual appearance of the biochar from the SP remained consistently black for all dwell times and temperatures tested. The SP did not show much color change over the range as the lowest temperature, 300° C., would be past the Maillard reaction's upper limits. In FIGS. 4a-d, the biochar SEM images for select samples from SP can be seen in which the structure changed as the temperature increased. Notably, SP biochar samples still had the rigid structure of the fibrous corn stover structure. Nevertheless, Brunauer—Emmett—Teller (BET) analysis confirms that the structure does become more porous as the temperature increases. HTC and SP produced distinct biochar from each other, where the degradation of cellulose and hemicellulose played an important role. HTC led to lower surface areas and larger average pore sizes, while SP led to higher surface areas and smaller average pore sizes. The subcritical water of HTC and higher temperatures in SP leads to different reactions occurring and some were more prominent than others.

AC from Biochar Derived from HTC and SP. The biochars from the HTC and SP methods were chemically activated to produce AC for the adsorption of phenolic compounds. The properties of the ACs were characterized using X-ray photoelectron spectroscopy (XPS),

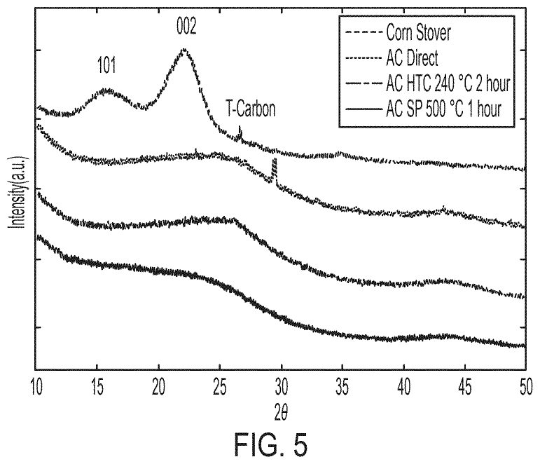

XRD, Fourier transform infrared spectroscopy (FTIR), and SEM and compared to that of direct chemical activation of the corn stover. The results of XRD of select ACs show the formation of amorphous carbon (FIG. 5). The AC XRD patterns have two broad peaks from ˜20 to 30 and ˜40 to 50 2θ. These represent amorphous carbon peaks as one would generally find broad peaks ranging from 10 to 30 and 35 to 50 2θ for amorphous carbon composed of aromatic carbon sheets oriented in a considerably random fashion. The XRD pattern for the direct activation of corn stover has a peak at 29.5°, which corresponds to silicate minerals in the sample. XPS was conducted to perform an elemental analysis of the biochar materials prior to and after activation with KOH. It was found that the O/C content of the HTC biochars and AC direct materials decreased after activation. However, the O/C content of the SP biochar remained the same. This confirms that the SP biochar is not as amenable as the HTC biochar for subsequent chemical activation by KOH.

Tables 1 and Table 3 contain the surface areas of the AC samples using biochar precursors from the direct, HTC, and SP methods.

TABLE 1
Surface Area and X-ray Photoelectron Spectroscopy Elemental
Analysis of the Biochar and the Associated ACs

| | surface | relative atomic concentration (%) | | | | |
|---|---|---|---|---|---|---|
| sample | area (m²/g) | O | N | C | S | O/C |
| CS | 1.2 ± 0.13 | 24 | 1 | 75 | 0 | 0.32 |
| SP500 | 5.0 ± 1.5 | 18 | 1 | 81 | 0 | 0.22 |
| HTC240 | 6.9 ± 1.3 | 22 | 1 | 77 | 0 | 0.29 |
| AC direct | 956 ± 39 | 17 | 0 | 82 | 0 | 0.21 |
| AC SP500 | 646 ± 19 | 18 | 1 | 81 | 0 | 0.22 |
| AC HTC240 | 1167 ± 164 | 13 | 1 | 86 | 0 | 0.15 |

TABLE 3
Activated carbon surface area of direct
activation, HTC, and SP precursors.

| | | Average | Micropore |
|---|---|---|---|
| | Surface Area²⁻¹ | Pore Size | Area²⁻¹ |
| Sample | mg | nm | mg |
| AC Corn Stover Direct | 956 ± 39 | 6.9 ± 0.09 | 814 ± 9.5 |
| AC HTC 200° C. 1 hour | 759 ± 71^{ε} | 5.7 ± 0.40^{ε} | 664 ± 58^{ε} |
| AC HTC 200° C. 2 hour | 940 ± 28 | 5.9 ± 0.56 | 821 ± 24 |
| AC HTC 220° C. 4 hour | 989 ± 92^{ε} | 8.5 ± 0.60^{ε} | 849 ± 74^{ε} |
| AC HTC 240° C. 1 hour | 984 ± 92^{ε} | 3.9 ± 0.27^{ε} | 812 ± 70^{ε} |
| AC HTC 240° C. 2 hour | 1,167 ± 164 | 6.0 ± 1.0 | 994 ± 121 |
| AC SP 300° C. 1 hour | 1,008 ± 94^{ε} | 6.9 ± 0.49^{ε} | 840 ± 73^{ε} |
| AC SP 400° C. 1 hour | 821 ± 77^{ε} | 4.6 ± 0.32^{ε} | 710 ± 62^{ε} |
| AC SP 500° C. 1 hour | 646 ± 19 | 4.1 ± 0.17 | 563 ± 20 |
| AC SP 550° C. 1 hour | 376 ± 107 | 4.4 ± 0.31 | 326 ± 102 |
| AC SP 600° C. 1 hour | 521 ± 49^{ε} | 4.0 ± 0.28^{ε} | 448 ± 39^{ε} |
| AC SP 650° C. 1 hour | 579 ± 24 | 4.4 ± 0.16 | 488 ± 4.4 |

^{ε}Approximate error calculated from previous data replicates

Surprisingly, the highest surface areas were achieved with the direct and HTC biochar precursors. For example, the highest surface area from the activation of the HTC biochar sample prepared at 240° C. for 2 hours was 1167±164 m2/g. Milled corn stover with no prior treatment was activated as a control and observed a surface area of 956±39 m2/g. This surface area is around what can be found on many commercial ACs. The highest surface area from the AC SP series of experiments was from the biochar formed from the 300° C. 1 hour run at 1008±94 m2/g. The lowest achieved surface area was from 550° C. SP biochar at 376±107 m2/g. Despite having higher starting surface areas compared to HTC biochars, the ACs formed from SP biochars have lower surface areas than those created from HTC biochars. Thus, the increased biochar surface area is inversely proportional to the AC surface area; this trend can be seen in Table 3.

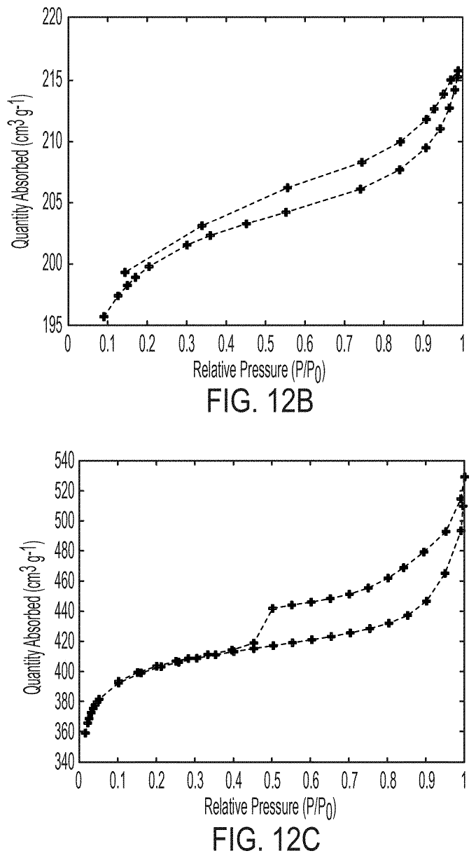

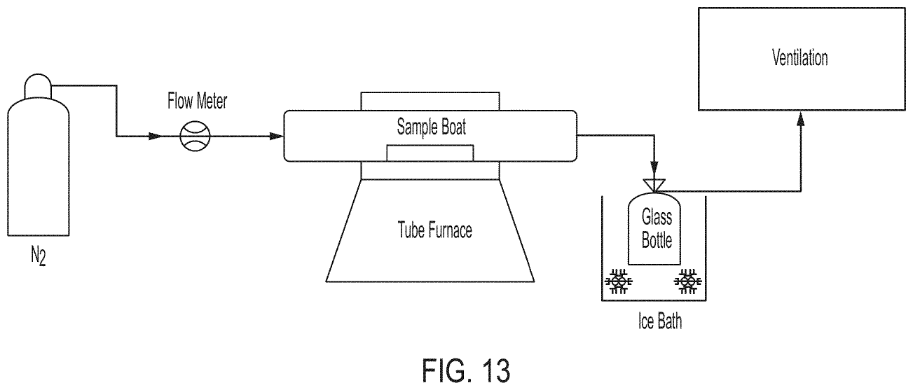

FIG. 12 shows the N₂ adsorption/desorption isotherms of the produced ACs. AC direct (FIG. 13a) and AC HTC (FIG. 13b) had the highest porosity, suggesting saturation of micropores and mesopores in the structure. The isotherm for AC SP (FIG. 13c) indicates a lower adsorptive capacity with a microporous structure. The average pore size of all the ACs as seen in Table 3 was between 4 and 9 nm, indicating that there are mesopores in each sample. There were minimal differences in the AC direct, AC HTC, and AC SP average pore size. The most noticeable difference between the samples was surface area primarily contributed by the micropore region. AC direct and AC HTC had surface areas with a higher micropore area.

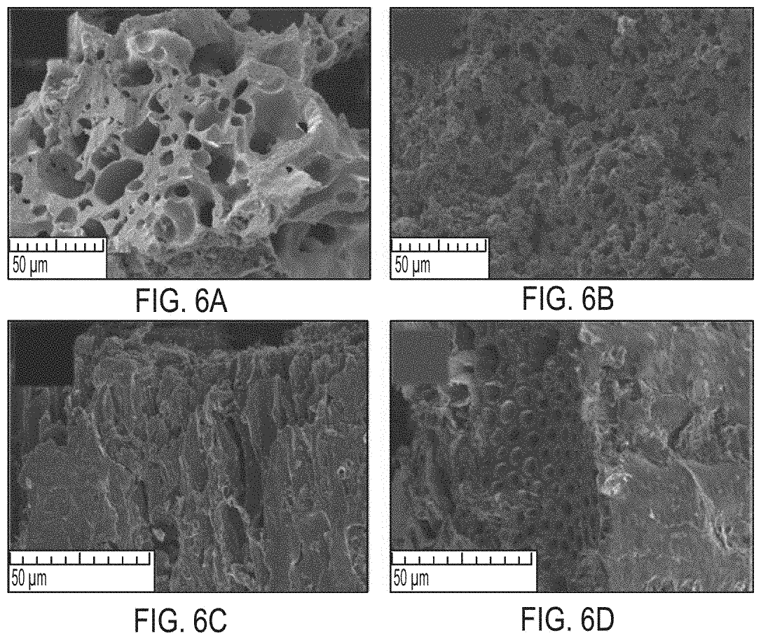

FIG. 6a-d shows the SEM images of the AC samples for select samples. The HTC AC images in FIG. 6a-d have a stark difference in appearance and morphology than the SP biochar AC images in FIG. 6c-d. The HTC biochar AC samples have significant surface changes with a clear breakdown of the rigid structure and courser appearance. This is especially apparent when compared to the original corn stover shown in FIG. 2a. The SP AC images from the SP biochar still have a rigid structure with less visible change compared to HTC ACs. The differences observed from SEM in the AC derived from either the HTC or SP biochar could indicate the differences in the surface area and pore sizes.

It was surmised that the difference in the maximum surface area achieved and the porosity for HTC biochar or SP biochar derived AC is due to cellulose and lignin concentration. For instance, a study by Tiryaki et al. created AC from tomato leaves that had 10.9% cellulose and 24.8% lignin that produced a surface area of 305 m2/g. In comparison, carbon with a higher cellulose content with a ratio of 26.2% cellulose and 36.5% lignin had a surface area of 839 m2/g. A study performed by Zhang et al. determined that as the lignin concentration increased, the surface area decreased. It was theorized that the polysaccharide structure of cellulose allowed the formation of a mesoporous structure. The complex polymeric aromatic structure of lignin though contributed to the layered and microporous structure. It was concluded that the SP biochars at high temperatures above 500° C. lack an appreciable amount of cellulose, corroborated by XRD, and thus are less prone to mesoporous structure formation. The hydroxyl groups in the cellulose and hemicellulose structure are reactive to the KOH chemical activation, reducing micropores. In contrast, lignin's aromatic backbone is more predisposed to produce macropores and carbon sheets. Thus, the HTC samples rich in cellulose are more prone to micropore formation.

### Adsorbent Properties of ACs for Vanillin.

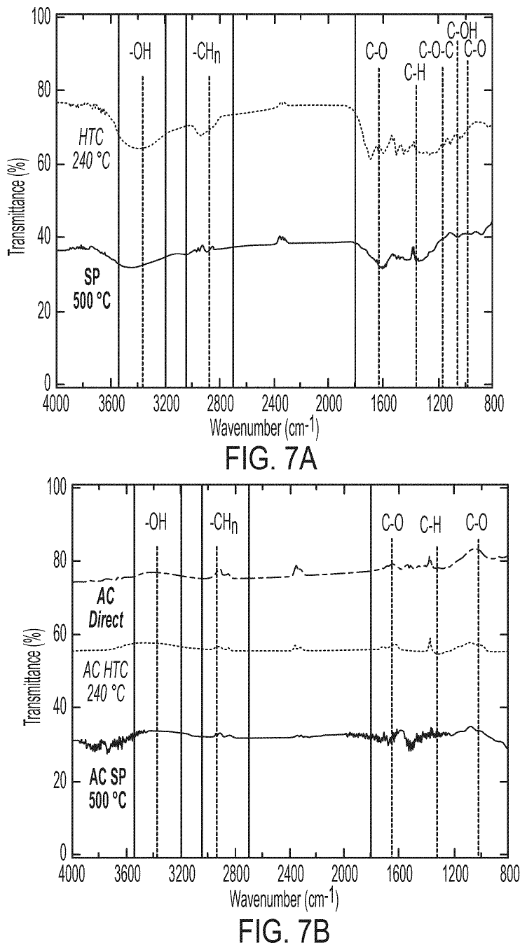

Characterization of Functional Groups. The adsorption characteristics of the AC HTC, AC SP, and AC direct materials depend on the surface functional groups. FTIR analysis was used to analyze the surface functional groups of the formed biochars and the associated ACs. FIG. 7a shows the comparative structures of biochar formed from HTC and SP. Both spectra show a broad band between 3150 and 3400 cm−1 attributed to the O—H stretching of the hydroxyl groups. The area between 3000 and 2800 cm−1 is attributed to the C—H stretching. The peak intensity for HTC 240° C. is greater, showing that there are more of these functional groups formed after hydrotreatment. The peaks between 1700 and 1650 cm−1 and at 1050 cm−1 can be assigned to the C—O stretching of the carboxyl groups. The peaks between 1100 and 1000 cm−1 refer to the C—OH and C—O stretch. These results indicate that the surface of the biochars is mostly oxygen-containing groups, including hydroxyl (—OH) and carboxylic (—COOH) functional groups. The ACs from all biochars formed from the direct, HTC, and SP had peaks indicative of C—O, C—H, and C—OH bonds as seen in FIG. 7b. The lower intensities infer that the surface of the carbon has predominant hydroxyl and C—O groups, however, at a lower concentration than the biochar precursors. This is also corroborated by the O/C ratio measured by XPS in Table 1, showing a lower O/C ratio than the biochars. The additional peaks and stronger intensity for the HTC corn stover over the other samples show that it has more oxygen-containing groups, which could be attributed to the higher concentration of cellulose and hemicellulose.

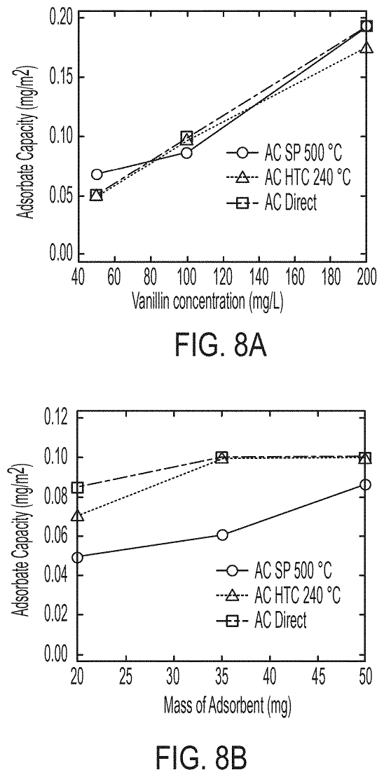

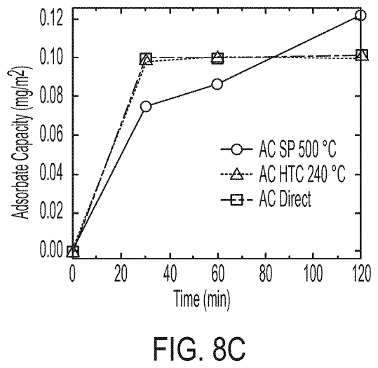

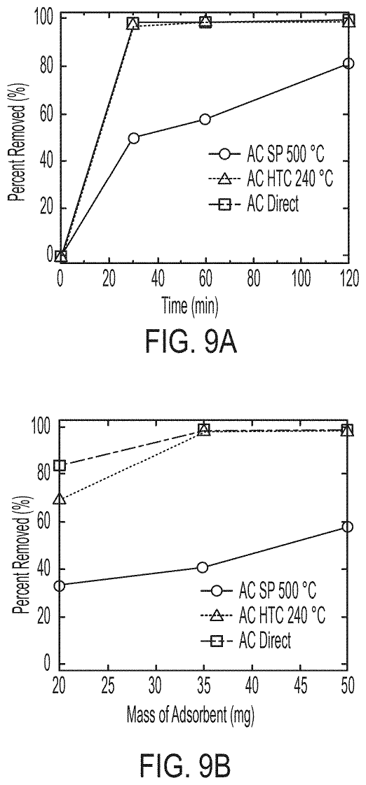

Adsorption Performance. The physical adsorption of vanillin molecules depends on the functional groups on the surface of the AC. The vanillin adsorption performance of the AC with respect to their biochar precursor characteristics and synthesis was evaluated. Batch adsorption experiments of the ACs were carried out, and the results are presented in FIGS. 8 and 9. The results show that the samples perform almost the same for concentrations between 50 and 200 mg/L (FIGS. 8 and 9a). For example, 98% of vanillin can be removed within 60 minutes by using the AC prepared from the corn stover direct method and the HTC biochar. Comparatively, it takes the AC prepared from the SP biochar greater than 120 min to adsorb 98% of vanillin.

The surface functional groups, pore volume, and pore size of AC positively influence the adsorption rate and amount of vanillin adsorbed onto the AC surface. Therefore, the effect of the mass of the AC to the reaction medium was used to determine the effects of the removal of vanillin. The solution volume and concentration were kept constant at 50 mL of 50 mg/L and were used at room temperature with a 60 min contact time. As shown in FIGS. 8 and 9b, at 2θ mg loading, AC direct had the best removal of vanillin at ˜14% more removed than AC HTC and even greater for AC SP. While AC direct had slightly less surface area, it adsorbed more than AC HTC by a noticeable amount, which may have implications that surface area is not the only parameter that affects the adsorption of vanillin. Parameters like surface functional groups and pore structure may affect the adsorption of vanillin. Each sample adsorbed more vanillin when the loading increased from 20 to 35 mg, with AC direct and AC HTC having removed similar amounts. With further increased amounts, AC HTC and AC direct remained the same, and AC SP continued to increase in adsorption capabilities. At the 50 mg loading, over 98% is removed for AC direct and AC HTC, while only 58% is removed for AC SP. The surface and morphology of the AC SP are drastically different from the other two ACs. This can be seen in the normalized adsorption capacity, where even per m2 the adsorption of vanillin onto AC SP is less than that of the others. This is an indication that more than the surface area is involved in the removal of vanillin, which could be due to the number of adsorption sites, the pore structure, and/or the surface functional groups.

Surface functional groups can affect the adsorptive properties of AC. The presence of dissolved oxygen on AC can increase the adsorptive capacity of phenolic compounds through oxidative coupling reactions. From the FTIR data, the HTC biochar had more oxygen-containing surface functional groups than the SP biochar. However, when activated, distinguishing which has the most oxygen-containing surface functional groups becomes difficult. The results from the AC Direct and AC HTC are very similar, indicating similar surface functional groups, which may be a reason for the higher adsorption of vanillin compared to AC SP.

The contact time between the AC and vanillin is a critical parameter for the adsorption process; thus, contact time optimization was investigated. The effect of contact time on the adsorption of vanillin by the prepared ACs was examined at room temperature by using 50 mg of AC and 50 mL of 50 mg/L vanillin solution. The adsorption experiment was carried out for up to 2 hours to determine the adequate adsorption time, and the result is presented in FIG. 8c. The amount of the absorbed vanillin for AC HTC and AC direct increased from 0 to 30 min and plateaued afterward. The adsorption on SP, however, increased rapidly from 60 to 120 minutes. For AC HTC and AC direct, the results show that the adsorption sites were saturated after 30 minutes. The AC SP continued to adsorb as the time increased, indicating that the maximum adsorption had not been achieved. This shows a possibility that the adsorption rate for SP is slower when compared to that of the AC HTC and AC direct.

### Conclusions

The properties of biochar precursors and ACs that were chemically activated either from corn stover using the direct method, HTC, or SP were compared. XRD and BET analysis showed that HTC and SP biochar differed in their lignocellulosic composition after the reaction at elevated temperatures. The role of water in HTC plays an integral part in the decomposition of corn stover as it allows hydrolysis and other reactions to break down the biomass more efficiently than SP. SEM analysis showed that the HTC and SP biochars formed more pores as the temperature increased. FTIR spectroscopy analysis showed that HTC biochars had a higher density of oxygen-based surface functional groups than SP biochars. Additionally, the formed AC from corn stover and HTC biochar precursors was apparently more oxygen rich.

The AC formed from the studied biochar precursors was then probed for the adsorption of vanillin. The lignocellulosic composition of the biochar is influential on the surface area, pore size, pore structure, and available surface functional groups for the formed ACs. In terms of their adsorptive abilities, the AC direct and AC HTC had significantly better adsorption of vanillin than the AC SP. When normalized to the surface area, AC direct and AC HTC had improved performance compared to AC SP as a function of duration and the total AC amount used, which implies that other properties such as pore structure and surface functional groups are important. The AC direct and AC HTC performed better than AC SP, indicating the importance of the biochar pretreatment method to AC properties. Overall, AC was produced from a highly relevant agricultural residue, corn stover. The results suggest that the AC generated directly from corn stover had properties comparable to the absorbents made from HTC and SP biochars. The production of AC as adsorbents for phenolic compounds may not warrant the extra thermochemical step of biochar precursor synthesis from HTC and SP.

### Materials and Methods

Hydrothermal Carbonization. A 300 mL Series 4561 Bench Parr Reactor was used for the HTC reactions. Corn stover was milled to 1 mm. Deionized water and corn stover were 8:1 by mass, unless noted otherwise, to the reactor and purged with nitrogen for 10 minutes. The reactor was heated and held at the desired dwell temperature for 1, 2, or 4 hours. Once finished, the reactor was submerged in ice water to stop the reaction. The liquid and solid phases were separated using vacuum filtration. The solid phase was rinsed with 300 mL of DI water to remove most of the bio-oils, leaving the solid biochar behind. While a portion of the liquid phase is not water-soluble and may still be left in the porous solid structure, it is believed to be a negligible amount. The biochar was dried overnight in an oven at 105° C. before chemical activation with KOH.

Slow Pyrolysis. A Thermo Scientific Type 1315M Benchtop Muffle Furnace inside a nitrogen glovebox was used for SP. Corn stover, milled to 1 mm, was placed inside a crucible and purged in a nitrogen environment. The sample was then placed in the muffle furnace and heated to the desired temperature at a ramp rate of 10° C./min. The sample was held for 1, 4, or 8 h at the desired temperature and then allowed to cool to room temperature.

Chemical Activation of Biochar. The same muffle furnace setup for the SP experiments was used for the chemical and thermal activation of carbon. The biochar, either from HTC or SP, was combined with KOH in a 2:1 ratio of biochar to KOH by mass. DI water was added to the mixture and stirred for 1 hour to ensure it was homogeneous. The mixture was then dried in an oven at 105° C. The sample was transferred into the nitrogen environment muffle furnace, heated to 300° C. for 2 hours at a ramp rate of 10° C./minute to remove moisture, and then further heated to 800° C. for 3 hours with a ramp rate of 10° C./minute. Once cooled, the sample was washed with a 0.1 M HCl solution to neutralize any remaining KOH. The sample was vacuumed-filtered and washed with DI water until the filtrate was pH neutral. The sample, now AC, was dried in an oven overnight at 105° C. before characterization. For the direct chemical activation method, corn stover replaced the biochar in equal amounts and the rest of the procedure for chemical activation remained the same.

Surface Area Analysis. Surface analysis was conducted using the Micromeritics ASAP 2020 and ASAP 2020 Plus physisorption instruments to perform BET measurements. The sample was loaded and degassed for 4-11 hours until an outgassing rate of less than 5 μmHg/min was achieved to ensure moisture and volatile contaminants were removed before analysis. N₂ physisorption and five-point BET analysis were used to measure the surface area, pore volume, and pore size. The BET was calibrated with a silica—alumina reference material with a standard error of 2.5%. Replicates of most of the biochar and AC were performed to determine the intrinsic errors in the surface areas and pore sizes with 95% confidence levels.

Scanning Electron Microscopy. A TESCAN Vega3. SBH SEM was used to capture images of the various corn stover, biochar, and AC samples. A Thermo Fisher Scientific NNS450 was also used to capture images of AC samples. Before imaging, the samples were placed under vacuum, purged with argon, and then sputter-coated with Au for 10 seconds to improve the clarity of the images. The images were taken between 900 and 1700 times magnification with a voltage of 5 kV.

XRD and XPS. A PANalytical Empyrean Series 2 XRD instrument was utilized to evaluate the carbon structures. The emission source was Cu Kα (1.54056 A wavelength) with a Ni beta filter. A zero-diffraction plate was employed to minimize the background peaks. XPS characterization was carried out using a Kratos AXIS ULTRA XPS system equipped with an Al X-ray source and a 165 mm mean radius electron energy hemispherical analyzer. Neutralizing was applied during the measurements to compensate for sample charging.

Fourier Transform Infrared Spectroscopy. Surface functional groups of char and the ACs were investigated using an FTIR Spectrometer (Nicolet iS10, Thermo Scientific) equipped with a Diffuse Reflectance Infrared Fourier Transform Spectroscopy accessory (Praying Mantis, Harrick) and a High Temperature Reaction Chamber (HVC, Harrick). Gathered spectra was an average of 64 scans with 8 cm−1 resolution between the range of 650-4000 cm−1. A general procedure would be diluting a small amount of the sample with KBr. The ratio of sample to KBr was about 1:100 by mass. The mixture was ground into a fine powder with a pestle and mortar and loaded into the chamber. The sample was held at 100° C. under helium flow for 50 minutes before a spectrum was taken. A background spectrum consisting of only ground KBr was collected under the same heating conditions before FTIR experiments were done that day.

Batch Adsorption Study of Vanillin. The batch experiments of the vanillin adsorption studies using the AC from SP, HTC, and the direct method were conducted at room temperature in a 150 mL beaker. For each run, 20-50 mg of the adsorbent was placed in a beaker containing 50 mL of a vanillin solution, which had a range of concentration between 50 and 200 mg/L. The suspension was stirred for a desired time, between 30 and 120 minutes, using a magnetic agitator. After agitation, the suspensions were gravity-filtered. The concentration of the filtrate was determined by using an Agilent Cary 60 UV-visible spectrophotometer. The absorbance wavelength was measured between 200 and 500 nm at a rate of 60 nm/minute and a 0.50 nm interval. The adsorbate capacity, normalized to the surface area, was calculated using the equation below:

$$Adsorbate capacity = \frac{\frac{{C}_{0} - {C}_{t}}{m} V}{Surface area}$$

where Ct is the concentration of the adsorbate at time tin mg/L, C0 is the initial concentration of the adsorbate in mg/L, m is the mass of the AC in mg, V is the volume of the adsorbate solution in L, and the surface area of the adsorbent is in m2.

### Example 2

### Synergistic and Antagonistic Effects of the Co-pyrolysis of Plastics and Corn Stover to Produce Char and Activated Carbon

The use of plastics, such as polystyrene (PS) and polyethylene terephthalate (PET), has transformed society by providing protection and storage for food, fibers in our clothing, and containers for goods (Chamas, A., et al., ACS Sustain. Chem. Eng. 2020, 8 (9), 3494-3511). Due to PET and PS's low degradability, most plastic waste is discarded and accumulates in landfills (Gibb, B. C., Nat. Chem. 2019, 11 (5), 394-395). Few PET and PS recycling strategies allow for the full utilization of monomers or reuse into relevant products. PET consists of repeating ethylene glycol and terephthalic acid monomers and is resistant to microbial degradation, posing issues with environmental remediation and extensive accumulation in the environment (Yoshida, S., et al., Science (80). 2016, 351 (6278), 1196-1199; and Müller, R. J., et al., J. Biotechnol. 2001, 86 (2), 87-95). PS contains styrene monomer units that are difficult to depolymerize and can persist for over 100 years in the environment (Ho, B. T, et al., Biotechnol. 2018, 38 (2), 308-320). The stable attributes of PET and PS, with improved chemical resistance and durability, make them widely useful but exceedingly difficult to recycle. Finding ways to recycle or upcycle these plastics will be necessary to mitigate solid waste management issues.

Plastic upcycling is an emerging alternative to mechanical recycling, where plastic waste is converted to value-added chemicals or materials such as activated carbon, fuels, waxes, and lubricants (Celik, G., et al., ACS Cent. Sci. 2019, 5 (11), 1795-1803; Zhuo, C., et al., J. Appl. Polym. Sci. 2014, 131 (4), 1-14; and Allred, R. E.; Busselle, L. D., J. Thermoplast. Compos. Mater. 2000, 13 (March 2000), 92-101). One technique to transform plastic waste into value-added products is using a thermochemical approach, pyrolysis, to break down the polymeric structure into three fractions: solid (char), liquid (pyrolysis oil), and gas, which can be valorized into chemical commodities and activated carbon. A strategy incorporating the existing biorefinery framework seeks to include natural (cellulose, hemicellulose, lignin) and synthetic (plastics) polymers in a process called co-pyrolysis (CoSP). Co-pyrolysis involves thermos-conversion of the biomass and plastic waste feeds in an oxygen-free environment with temperatures between 300-700° C. Pyrolysis oil is one of the most valuable fractions used as a feed for fuels and chemical commodities (Rutkowski, P. Waste Manag. 2009, 29 (12), 2983-2993; Rutkowski, P.; Kubacki, A., Energy Conyers. Manag. 2006, 47 (6), 716-731; and Abnisa, F, et al., Environ. Prog. Sustain. Energy 2014, 33 (3), 1026-1033). The solid product, char, can be used as a solid fuel or modified for improved adsorptive properties as activated carbon (Libra, J. A., et al., Biofuels 2011, 2 (1), 71-106). During co-pyrolysis, the high hydrogen/carbon (H/C) ratios and low oxygen/carbon (O/C) of plastic wastes work synergistically with the high oxygen/carbon (O/C) and low hydrogen/carbon (H/C) of lignocellulosic biomass, improving the quality of the products formed. Certain plastics, like PS, act as hydrogen donors in co-pyrolysis that promotes the hydrogenolysis or deoxygenation of the biomass fraction (Sharypov, V. I, et al., J. Anal. Appl. Pyrolysis 2007, 78 (2), 257-264; Wang, J, et al., J. Hazard. Mater. 2020, 386 (16), 121970; and Özsin, G.; Pütün, A. E., J. Clean. Prod. 2018, 205, 1127-1138). The synergistic relationship between plastic and biomass has improved the oil yield, quality, and composition (Önal, E.; Uzun, B. B., Energy Conyers. Manag. 2014, 78, 704-710; and Abnisa, F.; Wan Daud, W. M. A., Energy Conyers. Manag. 2014, 87, 71-85). The presence of plastic not only enhances the pyrolysis oil's content but can also contribute to changes in the chemical composition, surface, and porosity of the char formed. While there have been co-pyrolysis studies on the improvement of the pyrolytic oil, few studies (Özsin, G.; Puffin, A. E., J. Clean. Prod. 2018, 205, 1127-1138) have examined the char formed from the process to determine whether the properties are amenable for applications beyond use as a solid fuel. The quality of the char formed is primarily ignored, and additional research is needed on the formed char to optimize its properties as an adsorbent.

The physiochemical properties of char and activated carbon produced from the co-pyrolysis (CoSP) of corn stover (CS) and plastics, polystyrene (PS), and polyethylene terephthalate (PET) were studied. Non-isothermal gas analysis of the volatiles was analyzed using an online mass spectrometer to correlate the thermal degradation of gaseous byproducts to the formation of pores in the char materials. The findings determined that the addition of PS or PET promotes the formation of the solid char product with either higher than average pore sizes or surface areas compared to control samples. The addition of PET to corn stover increases the surface area of the char formed. The char formed from a CS:PET mass ratio of 1:1 produced char with a surface area of 423.8±24.8 m²/g at 500° C. and a duration of 2 hours. The surface area of the chars formed from CS and PET decreased as the amount of PET decreased, showing a tendency of PET to increase the surface area of the char materials synergistically. The addition of PS to corn stover promoted the formation of chars with, on average larger pore sizes than the control char samples. The chars were chemically activated with potassium hydroxide, and the activated carbon formed had lower surface areas but comparable surface functional groups to the control samples. Vanillin adsorption testing showed that activated carbon from corn stover performed the best at removing 95% of the vanillin after 2 hours. In contrast, the activated carbon from chars produced from the co-pyrolysis of corn stover and polystyrene or corn stover and polyethylene terephthalate removed 45% and 46% of vanillin after 2 hours, respectively. The findings suggest that plastics have a synergistic relationship in producing char precursors with improved porosity but antagonistically affect the activated carbon adsorbent properties.

### Results and Discussion

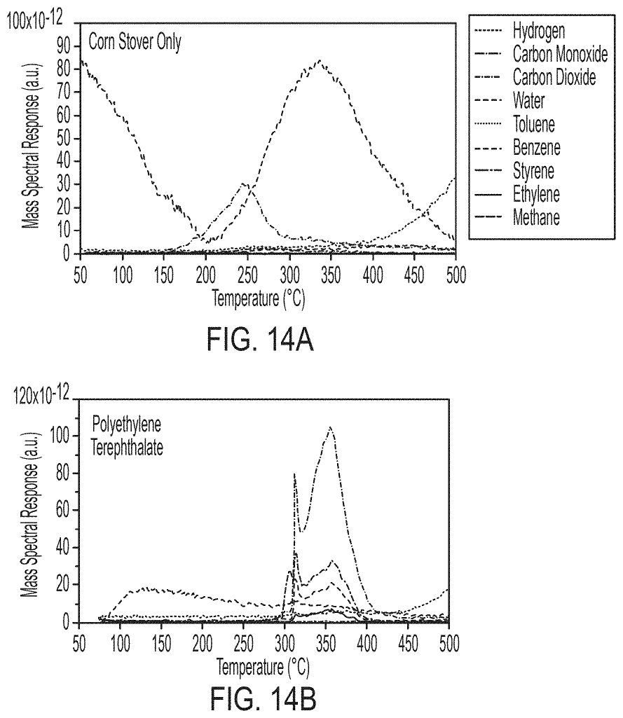

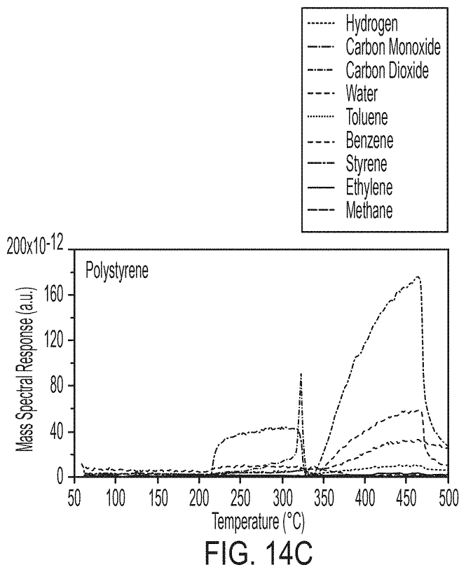

Thermal Degradative Studies for Char Formation. The volatiles and gaseous by-products produced during thermal pyrolysis were studied for corn stover (CS), polystyrene (PS), and polyethylene terephthalate (PET) as a function of temperature and are shown in FIG. 14. The thermal decomposition of corn stover occurs in two stages. The first stage involves the desorption of adsorbed water between 50° C. to 150° C. The second stage is the main pyrolysis stage, which occurs at about 150° C.; the most significant byproducts of pyrolysis are H₂O, CO₂, and CO. The production of H₂ at 400° C. is attributed to the continued breakdown of the solid residue formed during the temperature ramp. The initial by-products of the carbon oxides (CO₂ and CO) are most likely attributed to the breakdown of cellulose and hemicellulose, which has glucose and other sugar units with C-O fragments (Li, C., et al., Renew. Energy 2022, 189, 139-151) that can occur between 200 — 500° C.

The PET thermal breakdown occurs in two stages within the temperature range measured, as shown in FIG. 14(b). During thermal degradation, it is assumed that the polymer forms cyclic oligomers that form benzoic acid and terephthalic acid (Li, C., et al., Renew. Energy 2022, 189, 139-151). Further secondary cracking promotes the formation of gases (CO₂, CO, C₂H₄, CH₄, etc.) and condensable phases (Li, C., et al., Renew. Energy 2022, 189, 139-151). At temperatures above 50° C., there is desorption of adsorbed water. The second stage is the main pyrolysis stage at about 300° C. and starts with the generation of carbon dioxide, carbon monoxide, ethylene, benzene, and methane. The formation of CO and CO₂ is most likely attributed to the thermal decarboxylation of toluene dimethyl and benzoic acid, a byproduct of the cracking of PET (Li, C., et al., Renew. Energy 2022, 189, 139-151; and Li, C., et al., Int. J. Energy Res. 2021, 45 (13), 19028-19042). The primary pyrolysis occurs between 410-420° C. The generation of hydrogen at 440° C. could be attributed to the decomposition of the residual char. The thermal degradation of PS is shown in FIG. 14(c). PS thermal breakdown occurs in two stages. The initial stage is at 210° C. and starts with an extensive generation of carbon monoxide proceeding that of carbon dioxide. The second stage occurs at 345° C. and is the main pyrolysis stage that produces toluene, styrene, benzene, water, and hydrogen.

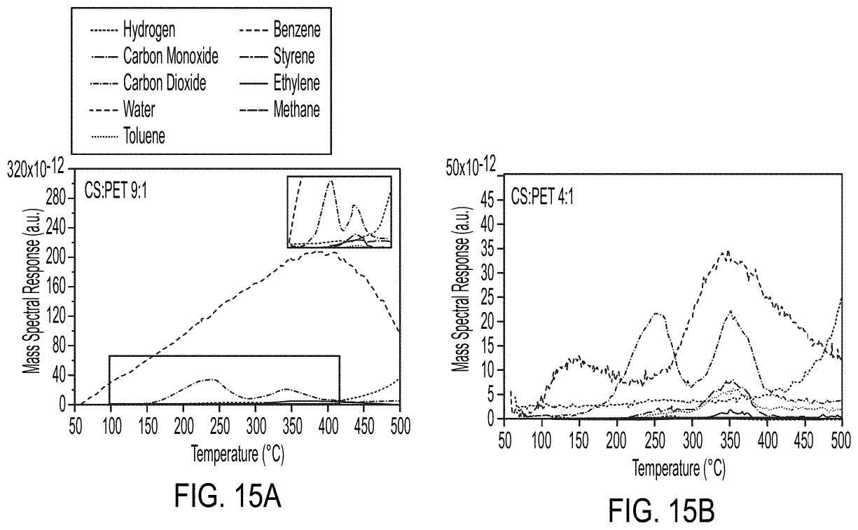

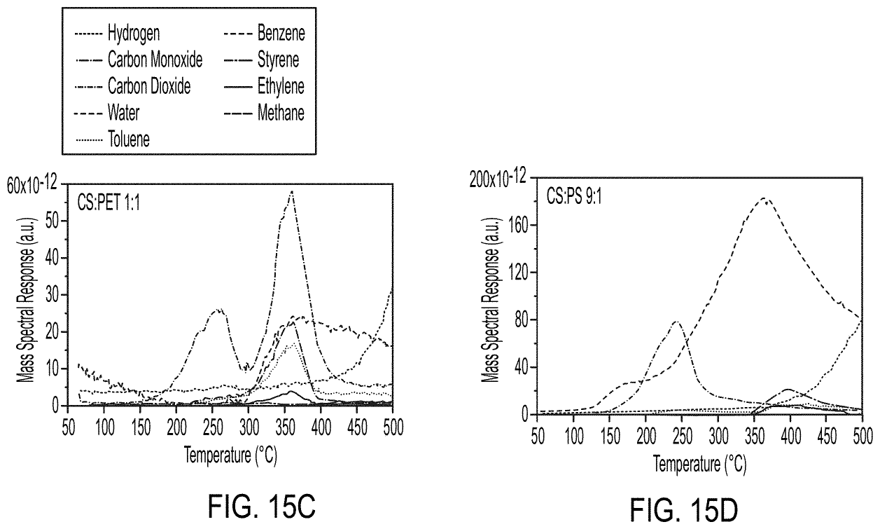

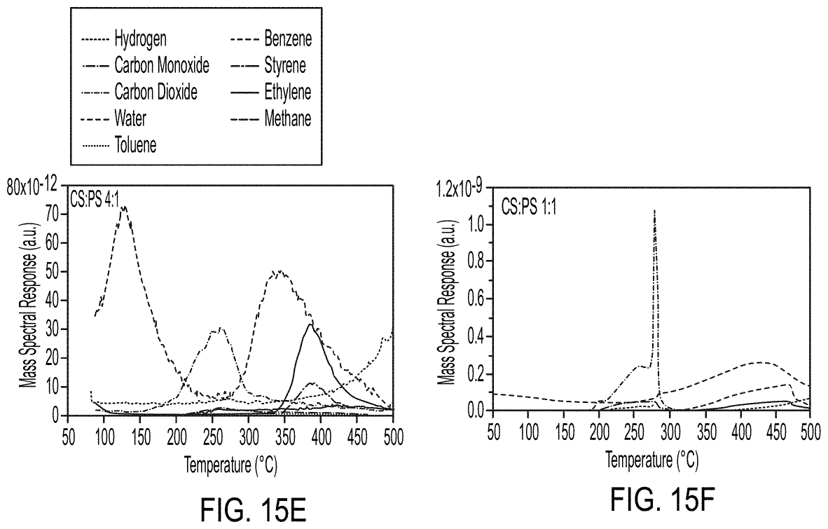

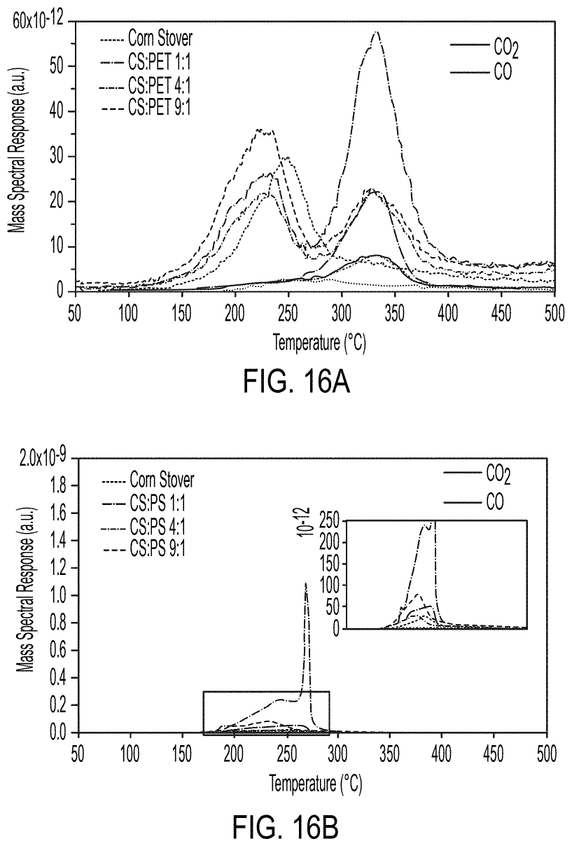

Gas evolution analysis was also used to determine if the combination of plastics and corn stover had synergistic interactions, shown in FIG. 15. For the co-pyrolysis samples, water production was dominant at lower temperatures due to the desorption of adsorbed water from corn stover. In FIG. 15(a-c), the CS:PET 1:1 starts with the initial degradative stage at about 175° C. with the generation of carbon dioxide; the second degradation event occurs at about 210° C. with increased production of carbon dioxide, water, carbon monoxide, methane, and ethylene. The release of hydrogen occurs at about 450° C. and is most likely attributed to the gasification of the formed char. CS:PET 4:1 has two breakdown stages, early outgassing of water followed by further water production at around 210° C. The generation of CO₂ starts at 150° C. and at 210° C. with the output of CO, C₂H₄, and CH₄. CS:PET 9:1 generates the largest quantity of water for the CS:PET combined samples. Like the previous samples, there are two breakdown events with initial CO₂ production at 145° C. and 265° C., with carbon dioxide, carbon monoxide, methane, and ethylene production. Hydrogen production occurs at around 450° C. FIG. 16(a) compares the carbon oxides as a function of corn stover and PET ratio. The analysis shows two primary means for generating the carbon oxides, initially from the breakdown of the biomass component at about 210° C. and the PET at 250° C. The largest generation of carbon oxides occurs with the lowest corn stover to plastic ratio. Interestingly, the mixture of PET decreases the onset of biomass degradation by about 10° C., showing an improved synergistic interaction. This corroborates previous findings by Li et al., in which the interaction of the PET-derived molecules influences the cracking behavior of cellulose (Li, C., et al., Renew. Energy 2022, 189, 139-151). The presence of water from the biomass also promotes the hydrolysis of the PET into char (Li, C., et al., Renew. Energy 2022, 189, 139-151).

FIG. 15(d-f) shows the gas analysis for corn stover and polystyrene composites. For CS:PS 1:1, the breakdown of the composite occurs in two separate phases; at 200° C., there is extensive production of carbon dioxide and carbon monoxide. The second production event occurs at 345° C. and initially produces toluene, followed by styrene, benzene, and hydrogen. The thermal degradation byproducts that initiate at 350° C. are attributed to the depolymerization of PS. The CS:PS 4:1 produces water initially from the desorption of water from the biomass fraction. CO₂ production initially occurs at 155° C. and the second generation occurs at 345° C. with increased production of styrene and ethylene. The CS:PS 9:1 has an initial breakdown of biomass occurring at 150° C. with the production of CO₂; the next phase occurs at 350° C. with increased production of styrene and related byproducts. For both samples, the water generation rate is the lowest, with a higher mass ratio of plastics. The breakdown of PS occurs initially with random scission to oligomers and eventually depolymerization to yield monomers such as styrene (Ahmad, Z., et al., J. Anal. Appl. Pyrolysis 2010, 87 (1), 99-107). The evolution of styrene, toluene, and benzene is attributed to the dehydration and demethylation reactions (Özsin, G.; Pütün, A. E., Energy Convers. Manag. 2017, 149, 675-685).

A study by Ganesh et al. postulates that the pore size and morphology of the char formed are directly correlated to the transport and amount of volatile generated (Raveendran, K., Char. Fuel 1998, 77 (7), 769-781). Thus, the more volatiles that diffuses out, the more pores are formed. The increase of volatiles and their rate of evolution also promote pore formation and pore dimensions. When the rate of volatile generation is high, the residence time of volatiles promotes the formation of macro- or meso-pores, which reduces the surface area and adsorbate capacity. The lower rate of char gasification produces more micropore development and a higher surface area. Thus, a higher rate of gasification would reduce the total surface area. During the carbonization of biomass and plastics, the initial stage forms residual char and promotes pore decomposition and pore formation. The volatiles from the gasification of the composite corn stover and plastic materials can accumulate in the already developed pores, or further char gasification can open these pores or enlarge the pore dimensions (Raveendran, K., Char. Fuel 1998, 77 (7), 769-781). The increase in volatile yield will reduce their residence time in the pores and the chances of pore blockage or condensation. The addition of plastics with corn stover should influence the char pore structure, surface area, and crystallographic structure, as discussed in section 4.

Char Properties from the Co-Pyrolysis of Corn Stover and Plastics

Surface Area Analysis of the formed Char. The physiochemical properties of the char from the co-pyrolysis of corn stover and polystyrene (CS-PS) and polyethylene terephthalate (CS-PET) were investigated. The surface area and pore size are crucial indicators of biomass breakdown into a carbonaceous material. Table 4 shows the surface area of neat CS and CS:PET of 1:1, 4:1, 9:1. The ratio that formed char with the highest surface area was a CS:PET ratio of 1:1 with a value of 423.8±24.2 m²/g.

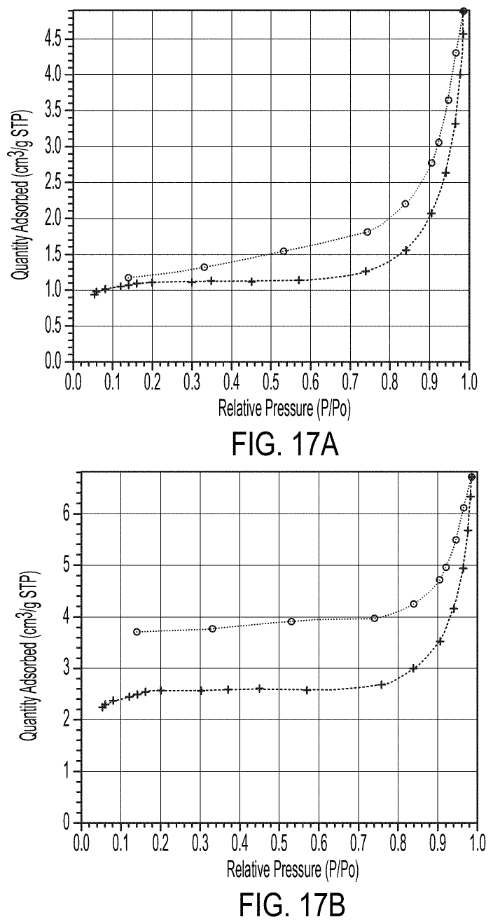

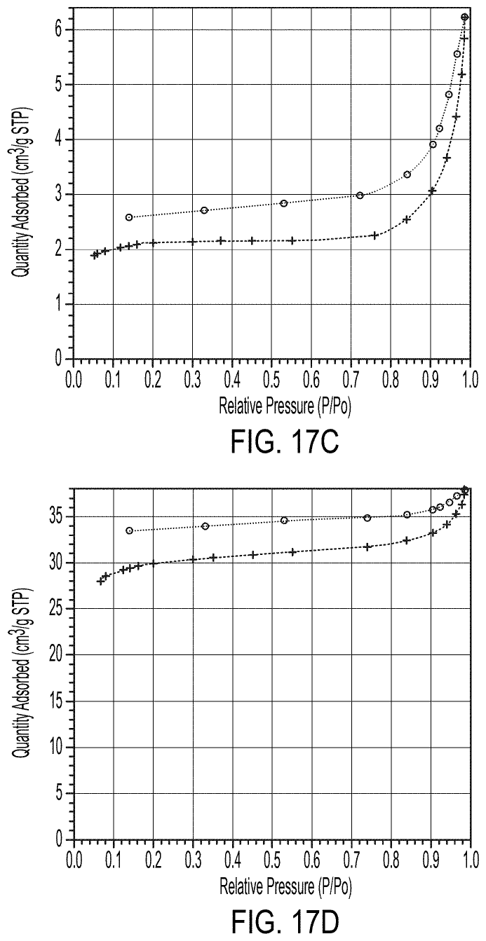

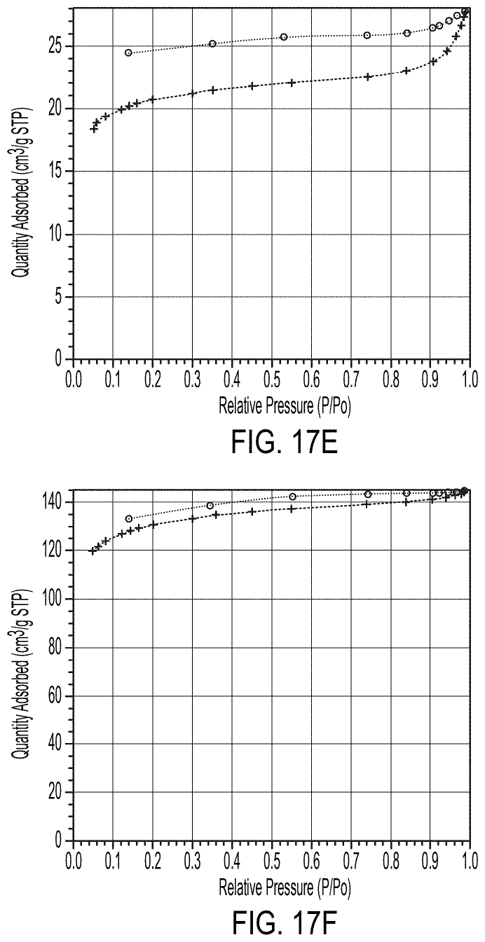

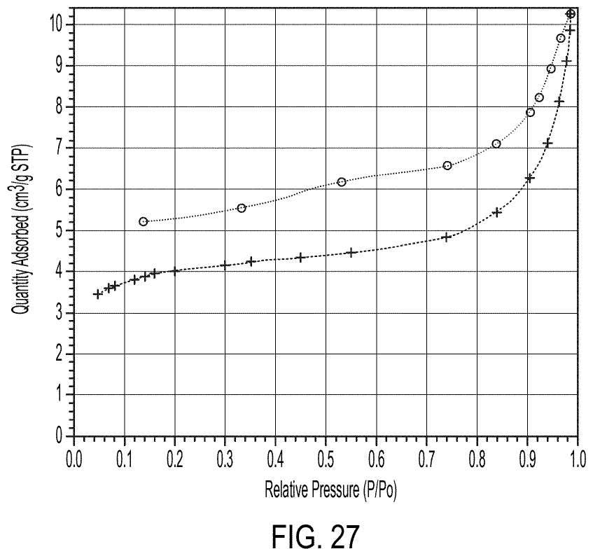

The surface area of 423.8±24.2 m²/g is one of the largest measured surface areas for char, where the average char surface area is generally between 1 — 10 m²/g. As the CS to PET ratio increases, the char surface area decreases, with the 4:1 and 9:1 chars having surface areas of 91.2±20.4 m²/g and 74.5±26.8 m²/g, respectively. Analogously, the pore size increases as the CS to PET ratio increases from 3.0±0.07 to 7.0±0.71 nm. The char from neat corn stover produced a significantly lower surface area of 12.4±3.7 m²/g when compared to the CS-PET chars. The N₂ adsorption/desorption isotherms of the chars formed from corn stover and PET are shown in FIG. 17(d-f). The isotherms show that the formed chars have a higher adsorptive capacity as the ratio of plastics increases. The adsorptive capacity is higher than the char formed from neat corn stover (FIG. 27). The material with the highest porosity is the CS:PET 1:1.

Thus, a higher amount of PET impacts the CS:PET char's surface area, adsorptive capacity, pore size, and char recovery amount (Buxbaum, B. Y. L. H., Angew. Chem. internat. Ed. 1968, 7 (3), 182-190; and Dimitrov, N., et al., Polym. Degrad. Stab. 2013, 98 (5), 972-979). Li et al. studied the influence of volatiles in the formed chars from the co-pyrolysis and sequential pyrolysis of PET and cellulose (Li, C., et al., Renew. Energy 2022, 189, 139-151). Analogous to our findings, they determined that the PET-derived byproducts interacted with char to change the internal structures and crystallographic structure of the char. The study also determined that the cross-interaction of the volatiles produced from

PET, such as the carbon oxides, further promoted the cracking reaction. It was surmised that two factors influence the surface areas of the composite CS:PET chars. The addition of PET generates byproducts like CO₂, CO, ethylene, and benzene that promote unblocking of already-formed pores in the char with the added benefit of creating a microporous structure and greater surface area. Additionally, it is believed that the presence of additional gases from PET-derived molecules can accelerate the breakdown of cellulose and hemicellulose, resulting in a char with more lignin content than that formed from neat corn stover. As lignin-rich biomass tends to have higher porosity and surface area (Zhang, N.; Shen, Y., Bioresour. Technol. 2019, 284, 325-332), it is believed that the improved surface area of the char is be attributed to the increase in volatile transport and formed char with higher lignin component.

The ratio of CS to PS was varied from 1:1, 4:1, and 9:1 to investigate the impact of the addition of PS on the properties of the char formed. Table 4 shows that the addition of PS has a nominal change in the composite surface area. The highest surface area of the chars containing PS was the 4:1 ratio at 11.7±2.8 m²/g. Generally, the measured pore sizes for the CS:PS chars were higher than the control sample, where the CS:PS 1:1 sample achieved a pore size of 32.2±2.7 compared to the control neat CS of 12.3±10.6 nm.

The N₂ adsorption/desorption isotherms of the chars formed from corn stover and PS are shown in FIG. 16(A-C). The isotherms show that the formed chars have a slightly higher adsorptive capacity as the ratio of plastics is increased. The adsorptive capacity is lower compared to the char formed from corn stover only. The material with the highest adsorptive capacity is the CS:PS 1:1. The trend suggests that PS synergistically promotes the formation of larger pores in the char and a smaller surface area with minimal changes in the adsorptive capacity. This is corroborated by a similar study from Ozsin et al. on the co-pyrolysis of biomass and polystyrene. Their team posited that the char formed during co-pyrolysis had a porous structure due to the increased diffusion rate of the evolved gases produced (Özsin, G.; Pütün, A. E. Energy Convers. Manag. 2017, 149, 675-685). The CS:PS chars had lower surface areas but larger average pore sizes than the control neat CS samples. Based on the experiments and gas evolution analysis, it was surmised that the thermal degradation breakdown of PS increases the residence time of formed volatiles in the pores of the char, increasing the relative size and lower surface area. The results indicate that the formed char comprises mainly carbonaceous species from corn stover, and the PS mass plays little to no part in the recovery amount of the formed char. This was also confirmed in thermal degradation studies where the char formed from PS was negligible when compared to PET and CS. The pyrolysis of PS with corn stover promotes the porosity of the lignocellulosic content promoting the transport of the formed volatiles and interactions of radicals occurring during degradation (Özsin, G.; Pütün, A. E., Energy Convers. Manag. 2017, 149, 675-685).

TABLE 4
The surface area of char as a function of the mass ratio
of corn stover and plastics (CS:PET and CS:PS ratio)

| | | | BJH | |
|---|---|---|---|---|
| | Sample | Surface | Pore | % Recovered |
| | CS-PS | Area | Size | as a function |
| | (2 h, 500° C.) | (m²/g) | (nm) | of corn stover |
| CS-PS | 1:1 ratio | 6.5 ± 0.8 | 32.2 ± 2.7 | 31.3% |
| | 4:1 ratio | 11.7 ± 2.8 | 19.6 ± 14.1 | 32.2% |
| | 9:1 ratio | 7.0 ± 3.2 | 22.3 ± 7.5 | 31.7% |
| CS-PET | 1:1 ratio | 423.8 ± 24.2 | 3.0 ± 0.07 | 53.2% |
| | 4:1 ratio | 91.2 ± 20.4 | 5.2 ± 0.57 | 39.3% |
| | 9:1 ratio | 74.5 ± 26.8 | 7.0 ± 0.71 | 36.1% |
| Neat CS | 1:0 ratio | 12.4 ± 3.7 | 12.3 ± 10.6 | 32.4% |

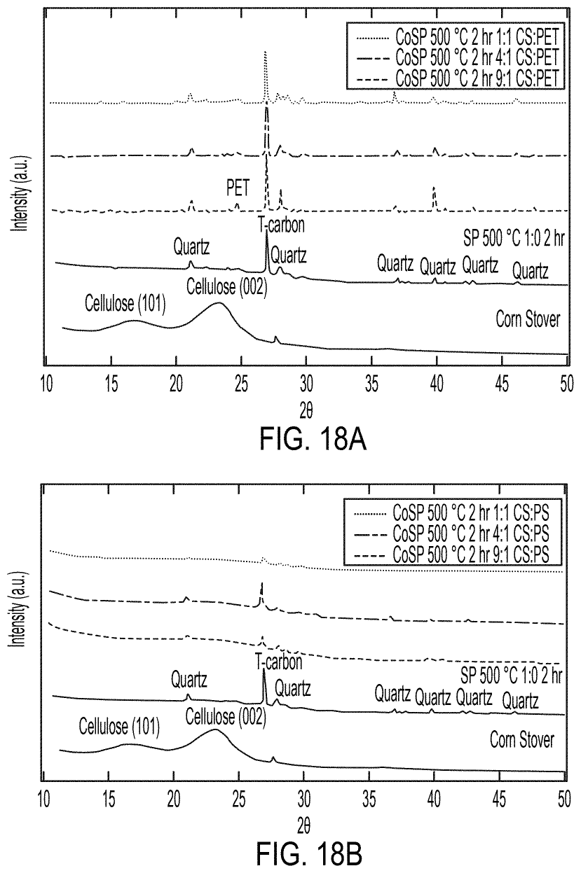

Composition and Crystallinity Analysis using X-ray Diffraction. FIG. 18 shows the XRD spectra of the chars produced from slow pyrolysis of corn stover and polystyrene or polyethylene terephthalate. The XRD spectra show the transformation of the composite corn stover and plastic materials to the carbonaceous structure of the formed chars. FIG. 18(a) shows the XRD of char formed from the co-pyrolysis of CS mixed with PET compared to char formed from the pyrolysis of neat corn stover at 500° C. The 4:1 and 1:1 CS:PET ratios show increased turbostatic or t-carbon peaks at 26.6° 20. The addition of PET may promote the breakdown of the CS biomass and the formation of the t-carbon graphitic layers increasing the surface area as reflected in the surface area measurements shown in Table 1. However, the addition of PET also seems to influence the quartz peak, which overlaps with the PET diffraction peaks at 27 and 29 20 (Li, C., et al., Renew. Energy 2022, 189, 139-151). The appearance of new peaks at 27 and 29 20 with a higher mass fraction of PET confirms that some residual PET remains on the surface after the formation of char (Li, C., et al., Renew. Energy 2022, 189, 139-151). The peak at 20.6-21.2°, ˜27, ˜36, ˜44, and ˜47 2θ coincides with quartz carbon (Kevin Eiogu, I., et al., Am. J. Nano Res. Appl. 2020, 8 (4), 58; Melo, D. M. A., et al., Microporous Mesoporous Mater. 2000, 38 (2-3), 345-349; and Xiao, W., et al., Ind. Crops Prod. 2011, 34 (3), 1602-1606). When comparing the char XRD spectra from CS only to that of chars from CS-PET, there are more pronounced peaks of crystalline quartz carbon. The crystalline quartz peaks decrease in intensity with further addition of plastic. All CS:PET ratios show a peak at 24.3° 2θ, which is a peak reflective of PET³³. The XRD spectra indicate that there is residual PET on the surface of the char at detectable levels after pyrolysis at 500° C. PET degradation produces acids and oligomers that promote the breakdown of the char and form more t-carbon species. The PET degradation compounds may condense in the pores of the char forming small granules.

FIG. 18(B) shows the XRD spectra of the chars produced from the co-pyrolysis of corn stover and polystyrene. The CS:PS char spectra show the formation of turbo-static carbon but have a minimal formation of quartz carbon. There are no detectable levels of polystyrene on the char surface, which confirms the complete breakdown of polystyrene during the pyrolysis experiments. This corroborates prior studies that indicate PS contributes to minimal char formation and generally breakdown into a liquid and gas fraction (Özsin, G.; Pütün, A. E., J. Clean. Prod. 2018, 205, 1127-1138). As the mass ratio of CS:PS decreases, there is less prevalence of t-carbon. For instance, the 1:1 ratio of CS-PS char has less intense t-carbon and quartz carbon peaks than the 4:1 ratio or CS char. The trend suggests that PS influences the carbonization process and may suppress the formation of exfoliated layers (t-carbon).

Analysis of Functional Groups. FTIR was used to assess the surface functional groups on the formed chars. The FTIR of CS-PET char as a function of the CS:PET ratio is shown in

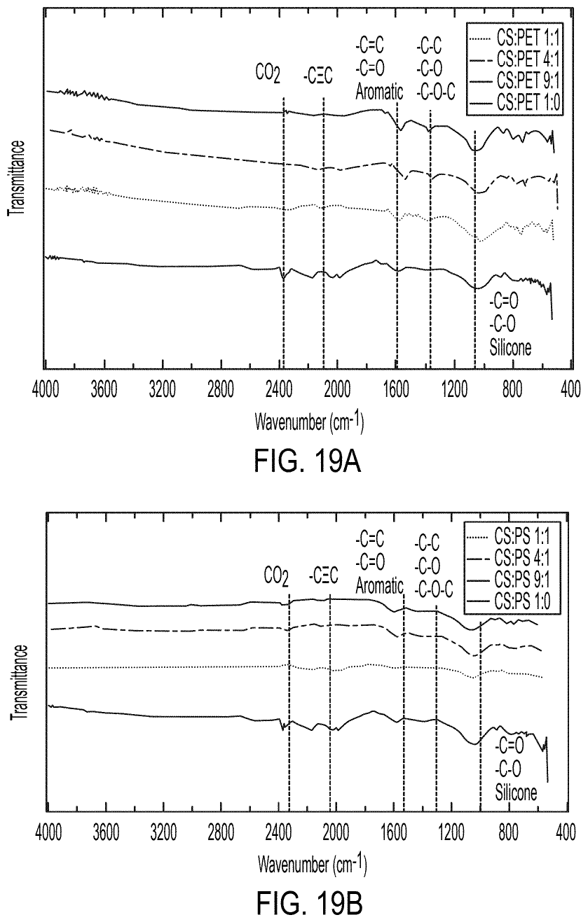

FIG. 19(a). The FTIR spectra show that for all corn stover and PET samples, there is stretching in the double bond region attributed to C═O and C═C. An additional peak is observed around 1400 cm⁻¹, indicating C—C, C—O—C, and C—O bonds. The FTIR spectra of the CS:PET as a function of the mass ratio do not differ much. However, it does appear that there is more prominence of the unsaturated carbon species as the amount of PET increases. The C═O and C—O stretching are observed on all the char around 880-1200 cm⁻¹. The FTIR also showed a potential residue PET polymer peak around 1400 cm⁻¹. The addition of PET promotes more aromatic surface functional groups in the char formed.

The FTIR of the CS-PS chars can be seen in FIG. 19(B). The chars of CS and CS-PS show some triple bond stretching around 2100 cm⁻¹ (CC). There is stretching in the double bond region around 1530-1610 cm⁻¹ which is attributed to C═O and C═C. The CS:PS 4:1 char has a more intense peak in the double bond region, whereas the char CS and CS:PS 1:1 have shallower peaks. The stretching of C—O and C═O from alcohols, carbonyl groups, and potentially silicone can be observed from 860-1200 cm⁻¹. As with PET, adding polystyrene to CS-PS increases the amount of aromatics and C═O functional groups in the formed solid product char. The source of the additional aromatic groups is most likely the styrene (PS) or terephthalic acid monomeric groups that form after the degradation of the synthetic polymer chains of the plastics.

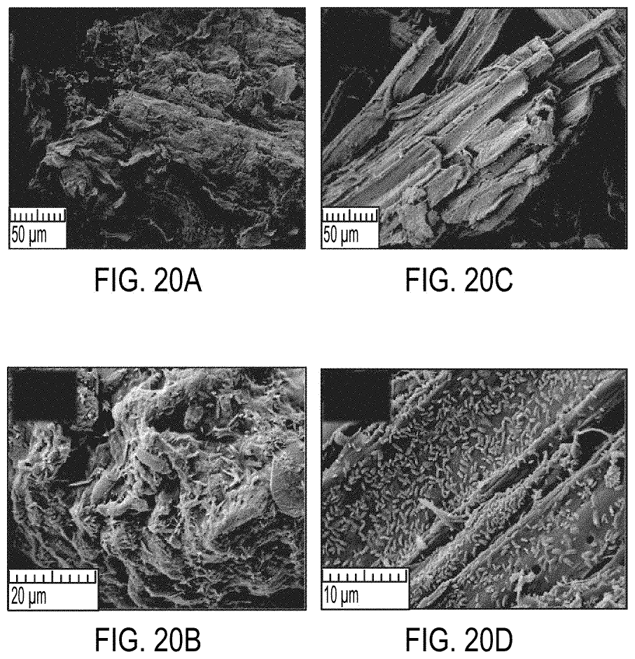

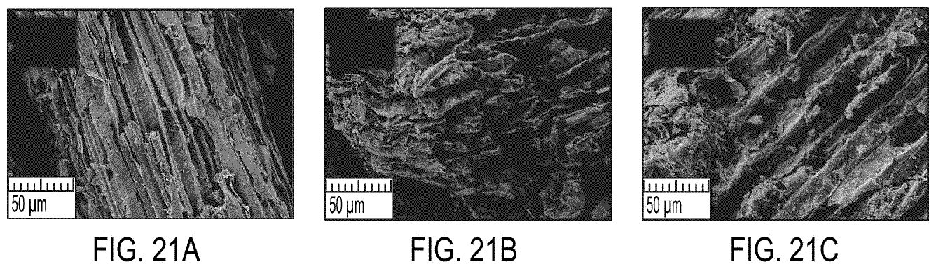

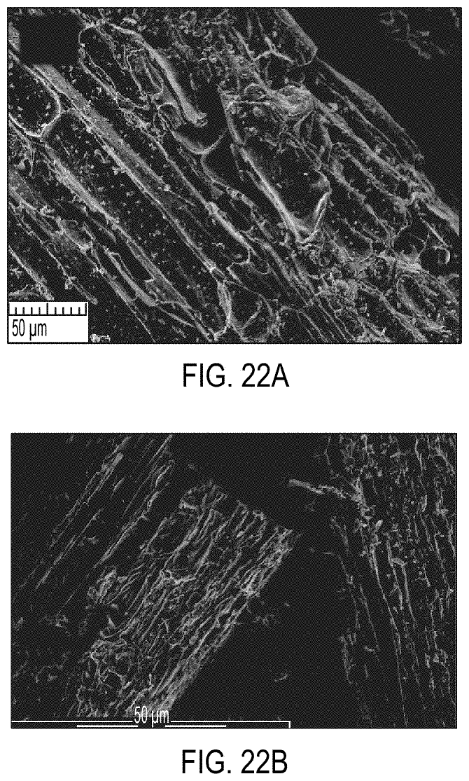

Morphological analysis of Char using Scanning Electron Microscopy. Select scanning electron microscopy (SEM) images of the CS:PET chars are shown in FIG. 20. FIG. 20 shows the SEM imaging of the PET char as a function of the CS:PET ratio. The images show the CS:PET ratios with the highest (CS:PET 1:1) and lowest (CS:PET 9:1) PET amounts. As can be seen from FIGS. 20(B) and 20(D), there are noticeable grain-like deposits on the char surface for both the CS:PET ratio of 1:1 and 9:1, respectively. The grain-like rice deposits are not shown in the SEM imaging of the control neat CS samples shown in FIG. 22. The grain-like deposits shown in FIG. 20(B) may be the formation of condensed PET oligomers on the surface identified earlier by XRD. The CS:PET 9:1 char shows wood-like structures and less degradation of the carbidic structure. The breakdown of the char differences is attributed to the content of plastic and biomass within the reactor. For instance, the CS:PET 9:1 has 80% more corn stover than the 1:1 ratio, which partially accounts for the drastic difference in the appearance of the char. The SEM images for CS-PS are shown in FIG. 21. The various ratios show no observable degradation or morphological differences in the samples as a function of the mass ratio. The CS-PS char resembles that of the char produced from CS (FIG. 22), and the wood-like structure of corn stover is still visible. Compared to corn stover mixed with PET, the addition of PS to corn stover during co-pyrolysis has minimal changes in the morphological properties of the composite char.

Activated Carbon Properties from Co-Pyrolysis of Corn Stover and Plastic

Physiochemical Properties of AC from CS and PET. The chars formed from the co-pyrolysis of corn stover and plastics were chemically activated using potassium hydroxide to produce activated carbon (AC). The properties of the activated carbons were characterized using XRD, Fourier transform infrared spectroscopy (FTIR), X-ray photoelectron spectroscopy (XPS), and SEM and compared to that of AC formed from the chemical activation of char-derived corn stover. Finally, the adsorptive properties of the AC to remove a phenolic compound vanillin was probed. The adsorptive properties indirectly measure how effective the available surface functional groups are in removing phenols from simulated wastewater.

TABLE 5
The surface area of activated carbon as a function
of the temperature and char composition.

| | Surface Area | |
|---|---|---|
| Sample | (m²/g) | Pore size (nm) |
| AC CS:PS 1:1 | 430.3 ± 15.6 | 4.2 ± 0.09 |
| AC CS:PS 4:1 | 477.0 ± 40.8 | 4.1 ± 0.04 |
| AC CS:PS 9:1 | 404.7 ± 5.7 | 4.7 ± 0.09 |
| AC CS:PET 1:1 | 409.2 ± 1.2 | 4.6 ± 0.01 |
| AC CS:PET 4:1 | 373.1 ± 17.1 | 8.5 ± 0.29 |
| AC CS:PET 9:1 | 390.1 ± 10.7 | 4.8 ± 0.25 |
| AC from Neat CS | 614.4 ± 0.2 | 3.9 ± 0.19 |

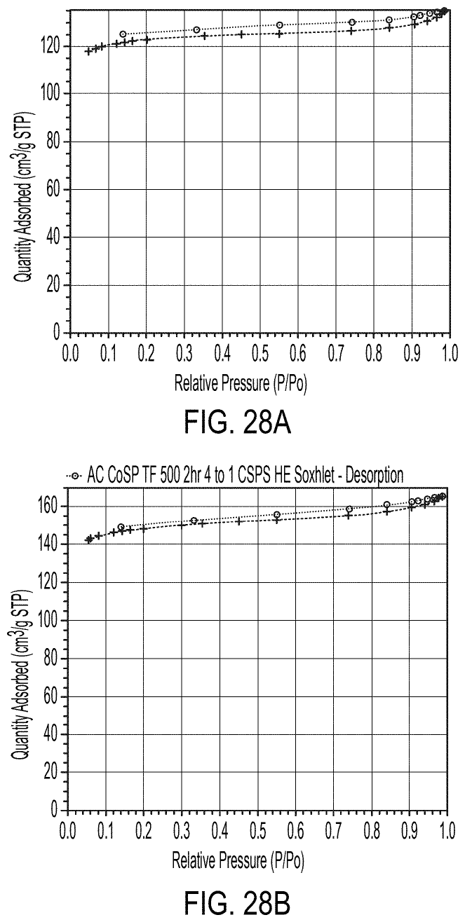

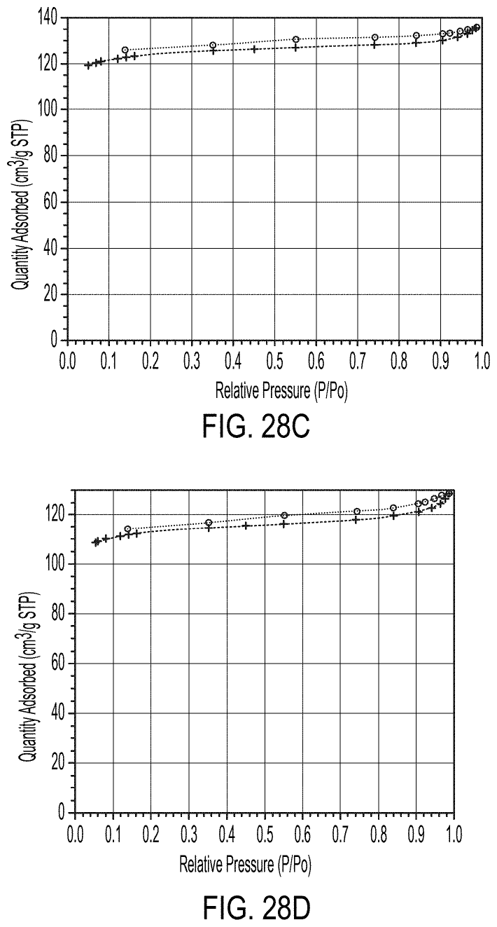

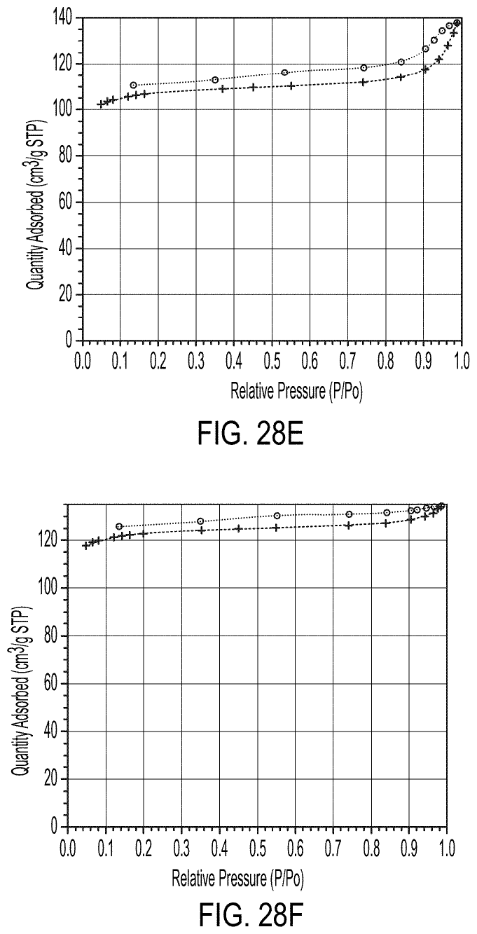

For AC derived from CS:PS, the material with the highest surface area (430.3±15.6 m²/g) was obtained from the char precursor formed from a CS:PS ratio of 4:1. There does not seem to be a noticeable trend in how the CS:PS ratio influences the surface area or pore size. The average surface area for all ACs formed from the char precursors from CS:PS is 437 m²/g. The AC surface area for CS:PS composite materials is considerably lower than that of the AC formed from corn stover only char precursors as can be seen in Table 5. The N₂ adsorption/desorption isotherms of the AC formed from corn stover and PS are shown in FIG. 28(a-c). The isotherms show that all the formed AC have a similar adsorptive capacity for all ratios studied.

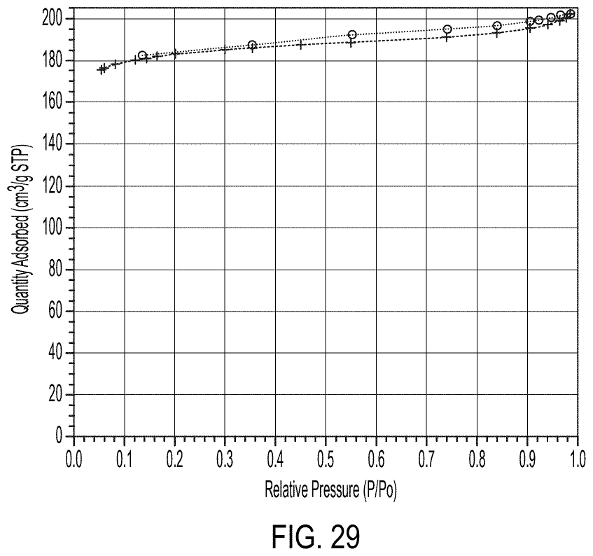

The adsorptive capacity is lower when compared to the AC formed from neat corn stover (FIG. 29). For AC derived from CS:PET, the material with the highest surface area, was AC CS:PET 1:1 with a value of 409.2±1.2 m²/g. The surface area of AC CS:PET 4:1 had a measured surface area of 373.1 m²/g. The obtained AC CS:PET 4:1 surface area is also the lowest for all ACs derived from the CS:Plastics composite materials. The average surface area for all ACs formed from CS:PET is 390.8 m²/g. The N₂ adsorption/desorption isotherms of the AC formed from corn stover and PET are shown in FIG. 28(D-F). The isotherms show that all of the formed AC have a similar adsorptive capacity for all ratios studied. The adsorptive capacity is lower when compared to the AC formed from neat corn stover (FIG. 29). It appears that the addition of PET is detrimental to the final surface area produced for the ACs. It was postulated that the addition of plastics modifies the crystallographic structure of the char formed, limiting the efficacy of chemical activation by KOH. Thus, the addition of PET and PS promotes the lignocellulosic cracking reactions forming chars with high surface areas and high lignin content. In a previous article on the slow pyrolysis of corn Gale, M., et al. discussed chars with higher lignin concentration tend to have lower surface areas where the aromatic backbone is more prone to produce macropores (Gale, M., et al., ACS Omega 2021, 6 (15), 10224-10233). Thus, the addition of plastics may be prohibitory to the surface area and porosity of the formed AC.

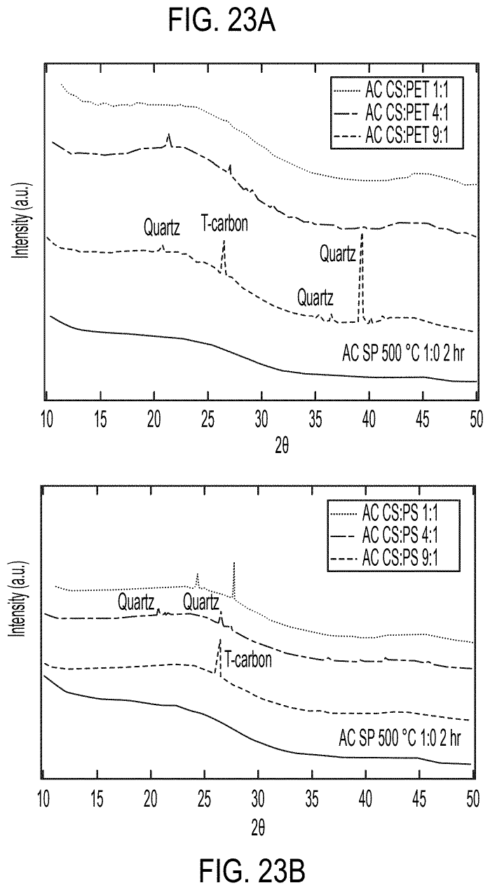

Composition and Crystallinity of Activated Carbon using X-ray Diffraction and X-ray Photoelectron Spectroscopy. FIG. 23 shows the XRD results for the AC from the

CS:Plastics composites. The XRD spectra for all AC CS:PET, shown in FIG. 23(A), show broad, amorphous peaks. However, as the ratio of CS:PET increases, turbo-static and quartz carbon's crystallographic peaks become more prominent and then decrease. For example, the AC CS:PET 1:1 peaks show amorphous peaks; as the amount of corn stover increases, graphitic and quartz carbon peaks are formed. The XRD for all AC CS:PS samples studied are shown in FIG. 23(B) and show amorphous peaks. Like AC CS:PET, the AC CS:PS shows pronounced crystallinity with turbo-static and quartz carbon peaks for all samples. The AC derived from the corn-stover char precursors is completely amorphized. The XRD spectra confirm that the presence of the plastics in the char precursors influences the carbonaceous structure of the formed ACs compared to the control AC sample.

The elemental analysis for the CS:Plastic 1:1 composite chars and related ACs were conducted using XPS, as shown in Table 6.

TABLE 6
XPS atomic surface composition of chars and activated carbon
from corn stover and plastics with a mass ratio of 1:1
formed at 500° C. and 2 h duration. The activated
carbon (AC) is made from the respective char precursors.

| | Surface Area | | | | |
|---|---|---|---|---|---|
| Sample | m²/g | C | O | N | O/C |
| Char CS | 124 ± 3.7 | 78 | 21 | 1 | 0.27 |
| Char CS-PS | 6.5 ± 0.8 | 81 | 18 | 1 | 0.22 |
| Char CS-PET | 423.8 ± 24.8 | 84 | 15 | 1 | 0.18 |
| AC CS | 614.4 ± 0.2 | 75 | 24 | 1 | 0.32 |
| AC CS-PS | 430.3 ± 15.6 | 73 | 26 | 1 | 0.36 |
| AC CS-PET | 409.2 ± 1.2 | 76 | 23 | 1 | 0.30 |

The CS-PET 1:1 created the lowest oxygen- containing char at 15%. The presence of acids can contribute to the acidic dehydration of cellulose, decreasing the O atoms of the lignocellulosic content. After chemical activation, the oxygen content increased to 23%, the lowest of the formed CS:Plastic ACs. For all AC measurements, the O/C ratio increased. For example, the activation of char-derived from corn stover only had a minor jump in oxygen content, from 21% to 24%, and AC CS:PS 1:1 had a more significant jump, 18% to 26%.

AC CS-PET had the lowest surface areas and had comparatively lower oxygen chars. The CS:PET and CS:PS char samples have the lowest oxygen content compared to the char derived from corn stover only samples. A prior study by Chen et al. determined the propensity of the activation of chars and the introduction of O-containing as a function of the amount of KOH added (Chen, T., et al., Fuel Process. Technol. 2016, 142, 124-134). It was postulated that the presence of plastics with the corn stover residue promotes additional side reactions that produce either excess hydrogen or acids that cause deoxygenation of the char.

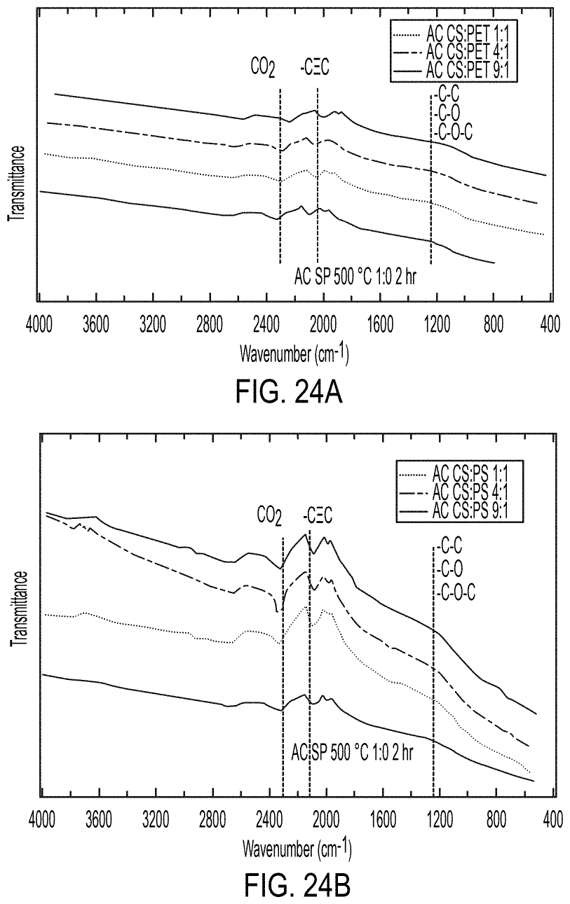

Morphological properties and the associated surface functional groups for the ACs. The adsorption characteristics of the AC formed from the CS:Plastic composites depend on the surface functional groups. FTIR analysis was used to analyze the surface functional groups of the ACs as a function of the compositions. FIG. 24 shows the FTIR results of the AC CS-PET and AC CS-PS activated carbons. The peaks for all the activated carbon are similar. The AC FTIR spectra have slightly different stretching intensities for adsorbed CO₂ and carbon triple bonds and a broad peak for the C—O and C—O—C stretches. Compared to the char's prominent prominent peaks for AC corresponding to surface functional groups, there are few C═C, and many of the peaks disappear in the fingerprint region. For AC CS:PETs for all ratios, there is also no peak around 1400 cm⁻¹ which may be credited to the breakdown of the PET after chemical activation in strongly alkaline conditions.

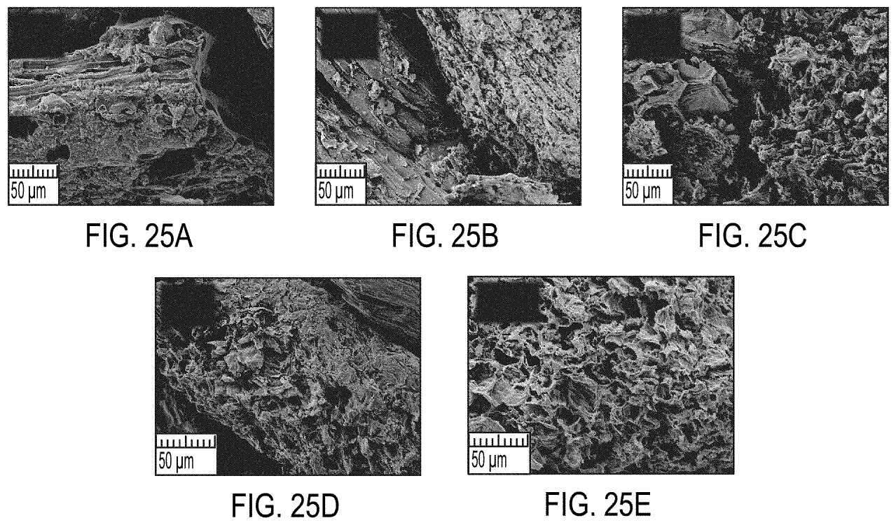

FIG. 25 shows the SEM images of select AC samples formed from CS:PET or CS:PS-derived chars. The AC CS:PS images show differences in surface structure and course appearance. The AC CS:PS peaks also have clearly defined pores and do not show any real changes in the morphology for all mass ratios. In comparison, the AC CS:PET shows the formation of the pores, which become more prevalent at a mass ratio of 9:1. This may corroborate the idea that the surface area and XRD spectra that the higher the biomass content of the char, the higher the propensity to activate the structure. Close inspection of the surfaces at higher magnification also does not see any granule structures, which confirms the breakdown of the PET granules condensed on the surface. This is expected as the high temperatures used for chemical activation promote the thermal degradation of the PET completely in an environment of strong alkaline conditions. In summary, the characteristics (prevalent functional groups, surface area, and morphology) of AC CS:PS and AC CS:PET are similar.

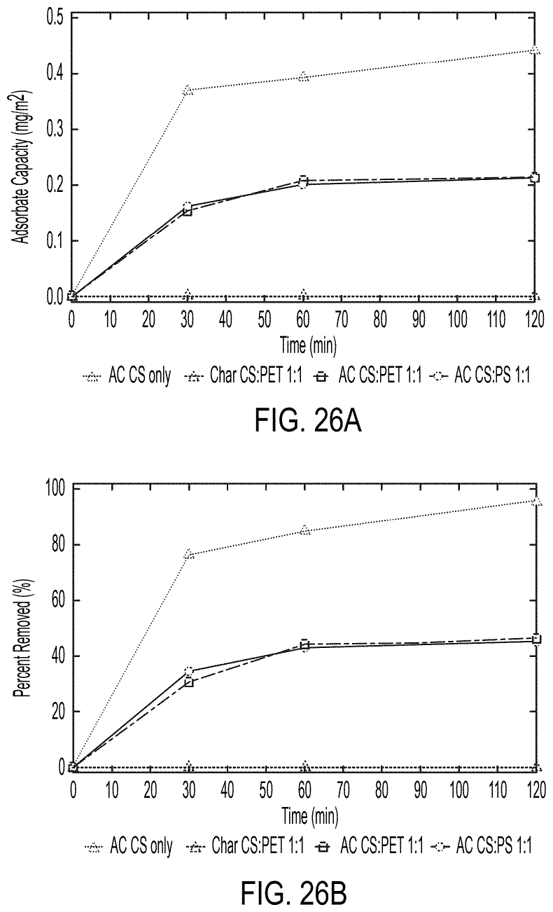

Adsorbent Properties of ACs for Vanillin. The adsorption characteristics of the porous carbon formed from CS:Plastic composites depend on the prominent surface functional groups. While the FTIR spectroscopy results show that all ACs have similar surface structures, the vanillin adsorption experiments indirectly measure the propensity of the porous carbons and ACs to adsorb pollutant species from water. FIG. 26 shows the AC CS removed 95% of the vanillin (100 mg/L) after 2 hours. AC CS-PS and AC CS- PET removed 45% and 46%, respectively, after 2 hours. The porous char from CS:PET 1:1 had negligible removal efficiency. The AC from CS-PS and CS-PET performed almost identically for all the trials. AC derived from CS outperformed the other ACs significantly across all tested durations.

While the higher surface area of AC CS played a role in better adsorption, it was postulated that the improved adsorbate capacity could be due to the number of adsorption sites, surface functional groups, and pore sizes. The detrimental performance of the CS:PET 1:1 char could be attributed to the limited pore size prohibiting the adsorption of vanillin and insufficient concentration of oxygen functional groups to promote physisorption. This is confirmed with XPS analysis of the O/C ratio (Table 6) which shows that CS-PET char has the lowest O/C concentration among all chars and AC measured. A calculation of the adsorbate capacity normalized to the surface area corroborates this theory. While AC CS:PS has a marginally higher surface area than AC CS:PET, the performance for both ACs derived from corn stover and plastic composites is about the same. The presence of the plastics in the char precursor produced an AC with inferior properties to adsorb vanillin additives. It is surmised this is attributed to the ineffective activation of the corn stover.

### Materials and Methods

Slow Pyrolysis and Co-pyrolysis. A Carbolite Gero Tube Furnace with a constant flow of nitrogen gas at a rate of 600 mL/minute was used for the pyrolysis experiments. The feedstock comprised either corn stover, milled to 1 mm, and a plastic, either Sigma Aldrich Polystyrene MW 192,000 (1 mm beads) or hand-cut 0.5 cm squares of PET plastic from plastic water bottles. The feedstock was placed in a ceramic boat and purged with nitrogen for 5 volumes of the reactor to ensure an oxygen-free environment. The sample was then placed in the tube furnace, heated to the desired temperature at a ramp rate of 10° C./min, held for the desired duration, and then allowed to cool to room temperature. The oil was collected using a single-pass cold trap attached to the end of the exhaust of the tube furnace. A schematic of the pyrolysis apparatus is shown in FIG. 13. For the purpose of this study, the pyrolysis experiments were conducted at 500° C. for 2 hours.

Chemical Activation of Char. A Thermo Scientific Type 1315M Benchtop Muffle Furnace inside a nitrogen glovebox setup was used for the chemical and thermal activation of carbon. The char was combined with KOH in a 2:1 ratio of char to KOH by mass. DI water was added to the mixture and stirred for 1 hour to ensure it was homogeneous. The mixture was then dried in an oven at 105° C. overnight. The sample was transferred into the nitrogen environment muffle furnace, heated to 300° C. for 2 hours at a ramp rate of 10° C./min to remove moisture, and then further heated to 800° C. for 3 hours with a ramp rate of 10° C./min. Once cooled, the sample was washed with a 0.1 M HCl solution to neutralize any remaining KOH. The sample was vacuumed-filtered and washed with DI water until the filtrate was pH neutral. The formed activated carbon (AC) was dried in an oven overnight at 105° C. before characterization. For the direct chemical activation method, corn stover replaced the char in equal amounts, and the rest of the procedure for chemical activation remained the same.

Thermal Degradation Pyrolysis Studies. Thermal degradative studies of the corn stover and plastic blends were studied at a heating rate of 10° C./min from a temperature range of 50° C. to 500° C. in a He flow of 40 mL/min using a fixed bed reactor coupled to a Hiden Quantitative Gas Analysis (QGA) mass spectrometer. Approximately 30 mg of the CS:PET and CS:PS blends were used. Mass spectral data were obtained with an electron energy of 70 eV and an emission current of 20 μA. The signals of the selected compounds were selected after preliminary scans of the samples. The experiments performed live tracking of co-pyrolysis gaseous products such as hydrogen (2 m/z), carbon dioxide (44 m/z), carbon monoxide (29 m/z), water (18 m/z), toluene (92 m/z), benzene (108 m/z), styrene (104 m/z), ethylene (28 m/z) and methane (16 m/z). The mass spectrometer was operated under a vacuum and detected the fragment ion and the intensity of the volatiles.

Surface Area Analysis. Surface analysis was conducted using the Micromeritics ASAP 2020 physisorption instrument to perform BET measurements. The sample was loaded and degassed for 8 hours until an outgassing rate of less than 5 μm Hg/min was achieved to ensure moisture and volatile contaminants were removed before analysis. N₂ physisorption and five-point BET analysis were used to measure the surface area, pore volume, and pore size. A silica—alumina reference material with a standard error of 2.5% was used prior to experiments to assess measurement errors. Most char and AC replicates were performed to determine the intrinsic errors in the surface areas and pore sizes with 95% confidence levels.

Scanning Electron Microscopy. A TESCAN Vega3 SBH SEM was used to measure images of the various corn stover, char, and AC samples. Before imaging, the samples were placed under a vacuum, purged with argon, and then sputter-coated with Au for 10 seconds to improve the clarity of the images. The images were taken at 1,000 times magnification with a voltage of 5 kV unless stated otherwise.

XRD and XPS. A PANalytical Empyrean Series 2 XRD instrument was utilized to evaluate the carbon structures. The emission source was Cu Kα (1.54056 A wavelength) with a Ni beta filter. A zero-diffraction plate was employed to minimize the background peaks. XPS characterization was carried out using a Kratos AXIS ULTRA XPS system equipped with an Al X-ray source and a 165 mm mean radius electron energy hemispherical analyzer. Neutralizing was applied during the measurements to compensate for sample charging.

Fourier Transform Infrared Spectroscopy (FTIR. Surface functional groups of char and the ACs were investigated using an FTIR Spectrometer (Nicolet 6700, Thermo Electron Corporation). The FTIR used a KBr beam splitter with a deuterated triglycine sulfate (DTGS) detector. The gathered spectra were an average of 16 scans with 4 cm⁻¹ resolution between 525-4000 cm⁻¹.

Batch Adsorption Study of Vanillin. The batch experiments of the vanillin adsorption studies using the AC and char were conducted at room temperature in a 150 mL beaker. For each run, 50 mg of the adsorbent was placed in a beaker containing 50 mL of a vanillin solution, which had a concentration of 100 mg/L. The suspension was stirred for a desired time, between 30 and 120 min, using a magnetic agitator. After agitation, the suspensions were gravity-filtered. The filtrate concentration was determined by using an Agilent Cary 60 UV-visible spectrophotometer. The absorbance wavelength was measured between 200 and 500 nm at a 60 nm/min rate and a 0.50 nm interval.

### Conclusion

The physiochemical properties of char and activated carbon produced from the co-pyrolysis of corn stover and plastic (PS or PET) were evaluated. The findings suggest that plastics synergistically affect forming chars with either larger pore sizes or larger surface areas. Gas analysis suggests that the evolution of gas byproducts from the cracking of synthetic and natural polymers can influence the char crystallographic structure, pore structure, pore size, and surface area. The activated carbon produced from corn stover/polystyrene and corn stover/polyethylene terephthalate had lower O/C composition, lower surface areas, and higher crystallinity than activated carbon derived from corn stover char. During co-pyrolysis, the breakdown of the plastics promotes additional side reactions (production of carbon oxides, methane, ethylene, etc.) that change the crystallographic properties, porosity, and prevalent surface functional groups of both the char and AC.

The chars from CS:PET 1:1 had the highest measured surface area at a 1:1 ratio, 423.8±24.8 m²/g. Adding PS to the corn stover promoted char formation with an average larger pore size and smaller surface area. The corn stover and polystyrene char, and ACs had no evidence of plastics in the residual carbonaceous products. All the ACs formed from corn stover/plastics performed inferior to the corn stover char-derived samples. This finding shows that the properties of co-pyrolysis char can be influenced by the interaction between the plastic and the biomass during the process. While the addition of plastics promotes side reactions that produce hydrogen or acids, contributing to a higher yield of the formed solid residue char. The alteration of the surface, porosity, and crystallographic structure due to the presence of the polymers may have an antagonistic effect on the properties of the chars as precursors for AC.

All publications, patents, and patent documents (including Gale M, et al., ACS Omega, 2021, 6, 10224-10233 and the documents cited therein) are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A method for preparing activated carbon comprising treating an amount of agricultural waste with less than one weight equivalent of an activating agent to provide the activated carbon.

2. The method of claim 1, comprising:
a) treating a composition that comprises agricultural waste with heat to provide a biochar; and
b) treating the biochar with less than one weight equivalent of the activating agent to provide the activated carbon.

3. The method of claim 1, comprising: treating a composition that comprises agricultural waste with an activating agent to provide a first reaction mixture; drying the first reaction mixture to provide a dried reaction mixture; heating the dried reaction mixture to a temperature of from about 250° C. to about 350° C. for a period of from about 1 hour to about 3 hours to provide a second reaction mixture; and heating the second reaction mixture to a temperature of from about 700° C. to about 900° C. for a period of from about 2 hour to about 4 hours to provide the activated carbon.

4. The method of claim 1, wherein the activating agent is KOH.

5. The method of claim 1, wherein the weight of the activating agent is less than about 0.75 times the weight of the agricultural waste.

6. The method of claim 2, wherein the composition that comprises agricultural waste also comprises plastic.

7. The method of claim 6, wherein the plastic comprises polystyrene.

8. The method of claim 6, wherein the plastic comprises polyethylene terephthalate.

9. The method of claim 1, wherein the activated carbon is suitable for removing organic impurities from water or air.

10. The method of claim 1, wherein the activated carbon has a surface area of less than about 1000 m2/g.

11. The method of claim 1, further comprising separating the activated carbon from the activating agent to provide isolated activated carbon.

12. The method of claim 11, further comprising contacting a water sample comprising organic contaminants with the isolated activated carbon under conditions such that at least some of the organic contaminants are removed from the water sample.

13. The method of claim 2, wherein the composition that comprises agricultural waste is treated with heat at a temperature in the range of about 250° C. to about 500° C. to provide the biochar.

14. The method of claim 2, wherein the composition that comprises agricultural waste is treated with heat under hydrothermal carbonization (HTC) conditions at a temperature of less than about 240° C. to provide the biochar.

15. A method for preparing biochar, comprising treating a composition that comprises agricultural waste and plastic with heat to provide the biochar.

16. The method of claim 15, wherein the plastic comprises polystyrene.

17. The method of claim 15, wherein the plastic comprises polyethylene terephthalate.

18. The method of claim 15, wherein the biochar has a surface area of at least about 50 m²/g.

19. An activated carbon prepared by the method of claim 1.

20. A biochar prepared by the method of claim 15.
